(19) United States
(12) Patent Application Publication
(10) Pub. No.: US 2026/0255127 A1
(43) Pub. Date: Aug. 27, 2026

(54) INFORMATION PROCESSING DEVICE, INFORMATION PROCESSING METHOD, AND PROGRAM

(71) Applicant: Sony Group Corporation, Tokyo (JP)

(72) Inventors: Rina KOTANI, Tokyo (JP); Shiro SUZUKI, Tokyo (JP)

(73) Assignee: Sony Group Corporation, Tokyo (JP)

(21) Appl. No.: 19/534,790

(22) Filed: Feb. 10, 2026

(30) Foreign Application Priority Data
Feb. 21, 2025 (JP) 2025-026946

(51) Int. Cl. H04S 7/00; H04S 1/00

(52) U.S. Cl. CPC H04S 7/307; H04S 1/007; H04S 2400/13

(57) ABSTRACT

Provided is an information processing device. The information processing device includes a processing unit that processes an audio signal of at least two channels. The processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

### CROSS-REFERENCE TO RELATED APPLICATION

This application claims the benefit of Japanese Priority Patent Application JP 2025-026946 filed on Feb. 21, 2025, the entire contents of which are incorporated herein by reference.

### TECHNICAL FIELD

The present technology relates to an information processing device, an information processing method, and a program, and relates to an information processing device, an information processing method, and a program for performing signal processing applying binaural masking level difference (BMLD), which is one of auditory psychological phenomena in humans.

### BACKGROUND

In the related art, techniques for emphasizing the sound to be heard by signal processing applying binaural masking level difference (BMLD), which is one of auditory psychological phenomena in humans, have been proposed.

For example, PTL 1 proposes that when a user listens to sound from earphones or headphones in a noisy environment, signal processing using BMLD is performed to make the sound to be heard (target sound) easier to hear by psychologically increasing its volume.

### CITATION LIST

### Patent Literature

PTL 1 WO 2023/189789

### SUMMARY

When performing signal processing applying BMLD, desirably, the volume can be adjusted so that the listener can hear the sound at an appropriate volume while preventing the listener from experiencing an unnatural auditory sensation.

In view of the foregoing, it is desirable to enable gradual change in volume by changing the magnitude of the effect of BMLD that enhances a target sound when performing signal processing applying BMLD.

An information processing device according to an embodiment of the present technology includes a processing unit configured to process an audio signal of at least two channels, in which the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

An information processing method according to an embodiment of the present technology is a method by an information processing device configured to process a sound and including a processing unit configured to process an audio signal of at least two channels, the method including, by the processing unit, setting a part of a band of the audio signal as an inversion frequency band and another part of the band of the audio signal as a non-inversion frequency band, generating, as the audio signal to be supplied to a first channel, a first added signal by adding an inverted signal obtained by phase-inverting a first audio signal corresponding to the inversion frequency band and a second audio signal corresponding to the non-inversion frequency band, and performing gain adjustment on an audio signal to be supplied to at least one of the first channel or the second channel.

A program according to an embodiment of the present technology is a program causing a computer to function as a processing unit configured to process an audio signal of at least two channels, in which the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

In the information processing device, the information processing method, and the program according to embodiments of the present technology, the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

Note that the information processing device may be an independent device or an internal block constituting a single apparatus.

Note that the program may be provided by being transmitted via a transmission medium or by being recorded on a recording medium.

### BRIEF DESCRIPTION OF DRAWINGS

FIG. 1 is a diagram for describing an overview of BMLD.

FIG. 2 is a diagram showing an example of frequency characteristics of BMLD.

FIG. 3 is a diagram illustrating an example of a signal processing method according to a comparative example.

FIG. 4 is a diagram illustrating an example of a signal processing method according to the present embodiment.

FIG. 5 is a diagram for describing a transition from physical sound pressure adjustment to psychological sound pressure adjustment.

FIG. 6 is a diagram for describing physical sound pressure adjustment and psychological sound pressure adjustment.

FIG. 7 is a diagram for describing a relationship between a volume adjustment value and a sound pressure adjustment.

FIG. 8 is a diagram for describing a range of an inversion frequency band.

FIG. 9 is a diagram for describing a variation pattern.

FIG. 10 is a diagram for describing a curve of a variation pattern.

FIG. 11 is an example of a graph showing a relationship between a volume adjustment value and an inversion frequency.

FIG. 12 is an example of a graph showing a relationship between a volume adjustment value and an inversion frequency.

FIG. 13 is an example of a graph showing a relationship between a volume adjustment value and an inversion frequency.

FIG. 14 is an example of a graph showing a relationship between a volume adjustment value and an inversion frequency.

FIG. 15 is a diagram illustrating a configuration example of a playback device.

FIG. 16 is a flowchart for describing volume processing.

FIG. 17 is a diagram illustrating another configuration example of the playback device.

FIG. 18 is a diagram for describing physical sound pressure adjustment and psychological sound pressure adjustment.

FIG. 19 is a diagram for describing physical sound pressure adjustment and psychological sound pressure adjustment.

FIG. 20 is a diagram for describing a configuration example of a PC.

### DESCRIPTION OF EMBODIMENTS

Hereinafter, modes for carrying out the present technology (hereinafter, embodiments) will be described.

For example, when listening to sound through earphones, headphones or the like, continuously listening at a relatively high volume may lead to deterioration of auditory function. By applying the present technology described below, it is possible to prevent the deterioration of auditory function even when the user listens to the sound at a relatively high volume for an extended period, while allowing the user to enjoy the sound at the desired volume. Here, a playback device that uses binaural masking level difference (hereinafter referred to as BMLD) to prevent deterioration of auditory function and to allow the user to enjoy sound at the desired volume will be described as an example.

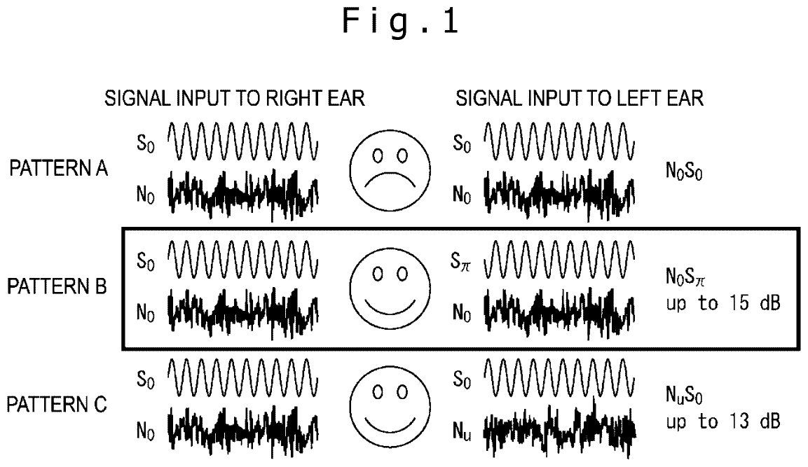

An overview of BMLD, which is one of auditory psychological phenomena in humans, is described below. FIG. 1 is a diagram for describing an overview of BMLD. In FIG. 1, “S” denotes an audio signal of a target sound that is to be heard, and “N” denotes an audio signal of a masker, which is a masking sound that masks the target sound. “○ (S or N) 0” indicates that there is no sound phase difference between the ears (left and right ears). “○ (S or N) π” indicates that the sounds presented to the ears (left and right ears) are in opposite phase to each other. “○ (S or N) u” indicates that the sounds presented to the ears (left and right ears) are uncorrelated.

The phenomenon in which the presence of a masker makes it difficult to detect the target sound is referred to as masking. The sound pressure level of the target sound at which the target sound can barely be detected due to the masker when the masker has a constant sound pressure is referred to as masking threshold.

As illustrated in patterns A and B of FIG. 1, BMLD is the difference between the masking threshold when a target sound of the same phase is heard under a same-phase masker (e.g., white noise), and the masking threshold when a target sound of the reversed phase between the ears is heard under the same-phase masker (white noise). While BMLD occurs even when the phase difference of the target sound between the ears is set to a freely-selected value other than 180 degrees (π), BMLD becomes maximal when the phase difference of the target sound between the ears is set to 180 degrees (π), thereby making the target sound easier to perceive.

For example, it has been reported that, comparing the case where a target sound presented in opposite phase between the ears is heard under the same white noise environment with the case where a target sound presented in the same phase between the ears is heard under the same white noise environment, presenting the target sound in opposite phase (phase-inverted) between the ears provides the listener with a psychological increase in volume equivalent to 15 dB (Hirsh, I. J. (1948). “The influence of interaural phase on interaural summation and inhibition.” Journal of the Acoustical Society of America, 20,536-544. the Internet URL: https://doi.org/10.1121/1.1906407).

Note that as illustrated in patterns A and C of FIG. 1, BMLD also occurs in a method where the target sound is maintained in the same phase between the ears, and the masker (e.g., white noise) is made uncorrelated between the ears. For example, it has been reported that this case provides the listener with a psychological increase in volume equivalent to 13 dB. In this manner, it is recognized that BMLD has an effect (hereinafter referred to as “BMLD effect”) of making the target sound easier to perceive under a masker environment.

The information processing device according to an embodiment of the present disclosure can solve auditory perceptual issues of a listener that may arise when performing BMLD processing by executing signal processing of inverting the phase of only a specific frequency band of a target sound.

As described below, when the frequency band of the target sound to be phase-inverted is limited, the BMLD effect is reduced compared to the case where the entire frequency band is phase-inverted; however, this can be utilized to adjust the effect of making the target sound easier to perceive.

It is desirable that the information processing device according to the embodiment of the present disclosure adjusts the target sound to the volume desired by the listener by using the aforementioned features. The information processing device according to the embodiment of the present disclosure can control the volume of the target sound by changing the magnitude of the BMLD effect by changing the range of the frequency band of the target sound to be phase-inverted. In addition, it is possible to control the volume of the target sound such that the frequency balance between the phase-inverted target sound and the non-phase-inverted target sound is not lost by controlling the volume even for the target sound in the frequency band that is not to be phase-inverted.

The frequency band to be phase-inverted is dynamically set in accordance with the volume adjustment value specified by the user. The frequency band corresponding to the volume adjustment value specified by the user is set, and signal processing of inverting only the phase of the signal of the set frequency band is executed, whereby the volume can be gradually changed while solving auditory perceptual issues of a lister that may arise when performing BMLD processing.

In the following, a playback device is described as an example of the information processing device according to the present disclosure. For example, the playback device may be an audio playback device, a communication terminal such as a smartphone, a personal computer, or the like. The playback device is not limited to existing playback devices and may also be a newly developed playback device, as long as the device plays back stereo audio. It is assumed that the audio signal processed by the signal processing method according to the embodiment is listened to using an audio output device such as stereo earphones or headphones. In addition, a listener wearing the audio output device is simply referred to as a “user.”

In the following description, among the frequency bands of the target sound, the frequency band to be subjected to phase inversion processing is referred to as “inversion frequency band”. Among the frequency bands of the target sound, the frequency band not to be subjected to phase inversion processing is referred to as “non-inversion frequency band”. The division of the sound into frequency components during signal processing is referred to as band division.

The above-described inversion frequency band may be set to a unique value corresponding to the frequency distribution of the sound by analyzing music or voice to be played back by the playback device in advance, for example. The inversion frequency band may also change from moment to moment in accordance with the frequency distribution of the target sound. The boundary of the inversion frequency may be sequentially changed in accordance with the noise level. The inversion frequency band may have a band-pass characteristic. The target sound is not limited to voice and may also be music. The inversion frequency band may be determined by analyzing the frequency distribution of the noise at any time and setting the boundary value of the inversion frequency band of the target sound in accordance with the frequency distribution of the noise.

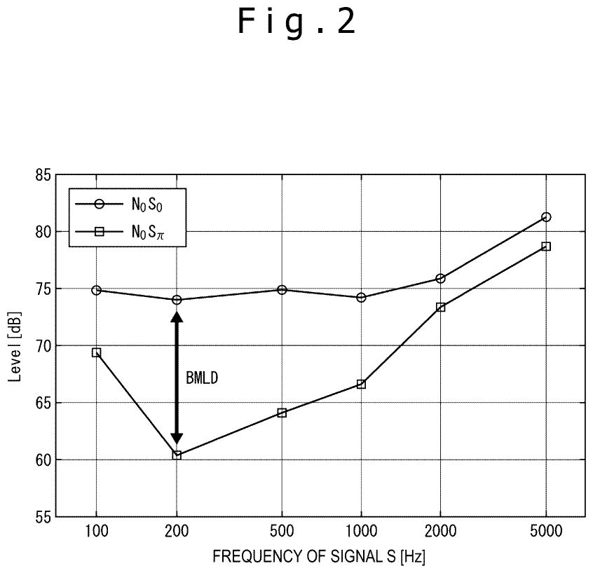

It is known that the magnitude of BMLD exhibits frequency dependence. FIG. 2 is a diagram showing an example of frequency characteristics of BMLD. As shown in FIG. 2, when the target sound is a sine wave, BMLD becomes maximal when the frequency of the target sound is 200 Hz (this frequency is hereinafter referred to as the “maximum BMLD frequency”).

As the frequency of the target sound increases, BMLD decreases. Near the maximum BMLD frequency, even a small change in frequency results in a sharp increase or decrease in BMLD, whereas in the high-frequency band, BMLD remains almost constant despite changes in frequency. As such, the inversion frequency band may be determined in consideration of such frequency dependence of BMLD.

It is expected that the signal processing executed by the information processing device of the present disclosure is used in environments where noise is anticipated, such as inside a train or in a crowd (hereinafter referred to as “noisy environments”). With this information processing device, when listening through headphones to audio sources pre-stored in the playback device or audio (such as music content or voice content) played online in noisy environments, or when making a call through the playback device, it is expected that the target sound, such as music, voice, or call audio, can be made more easily audible without physically amplifying the sound, even if the volume adjustment value is increased. In addition, since the target sound is not physically amplified, it is expected to have the effect of reducing the possibility of hearing loss caused by prolonged listening through headphones.

### Overview of Signal Processing Method According to Comparative Example

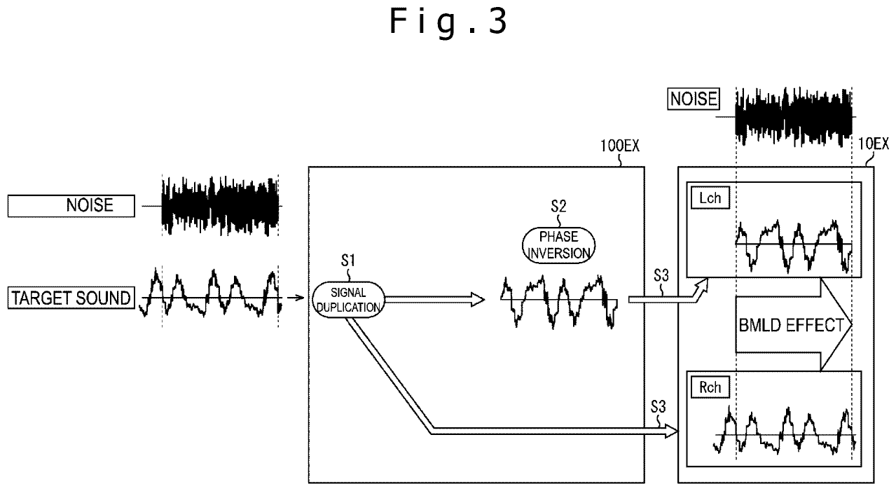

An overview of signal processing according to a comparative example with respect to the signal processing executed by the information processing device of the present disclosure is described below. FIG. 3 is a diagram illustrating an example of a signal processing method according to a comparative example.

As illustrated in FIG. 3, a playback device 100EX according to the comparative example duplicates a target sound (monaural signal) played back in noisy environments (step S1). The duplicated target sound is treated as audio signals for two channels of left and right.

The playback device 100EX according to the comparative example inverts the phase of one audio signal of the audio signals of the two channels (step S2). Note that the playback device 100EX according to the comparative example does not invert the phase of the other audio signal.

The playback device 100EX according to the comparative example outputs, to an audio output device 10EX, the phase-inverted audio signal and the non-phase-inverted audio signal in a synchronizing manner. For example, the playback device 100EX outputs the phase-inverted audio signal of the two-channel audio signals through a functional channel, and outputs the non-phase-inverted audio signal through a non-functional channel.

For example, the playback device 100EX outputs the phase-inverted audio signal to the left ear unit corresponding to the functional channel (Lch) in the audio output device 10EX. The playback device 100EX outputs the non-phase-inverted audio signal to the right ear unit corresponding to the non-functional channel (Rch) in the audio output device 10EX (step S3).

In this manner, the audio output device 10EX can provide the user wearing the audio output device 10EX with a target sound to which the BMLD effect is applied in noisy environments.

### Overview of Signal Processing Method of Present Disclosure

Hereinafter, an overview of a signal processing method according to the embodiment of the present disclosure is described. The signal processing method according to the embodiment of the present disclosure differs from the signal processing method according to the comparative example in that the phase inversion of the target sound is performed only on the frequency band (inversion frequency band) corresponding to the volume specified by the user, and a gain control corresponding to the volume specified by the user is performed on the frequency band not to be phase-inverted.

For example, the signal processing method according to the embodiment of the present disclosure executes the psychological sound pressure adjustment to which BMLD is applied when the volume specified by the user (hereinafter referred to as specified volume) is greater than a predetermined volume (threshold Vth). The psychological sound pressure adjustment is a process of adjusting the sound pressure using BMLD such that the user perceives that the volume desired by the user is obtained without changing the amplitude (maximum amplitude) of the waveform of the audio signal.

When the specified volume is equal to or greater than the threshold Vth and is close to the threshold Vth, the inversion frequency band is set to a narrow band, whereas when the specified volume is farther from the threshold Vth, the inversion frequency band is set to a wide band. In this way, the psychological sound pressure adjustment is performed in the inversion frequency band set in accordance with the volume.

By changing the inversion frequency band in accordance with the specified volume, the psychological sound pressure can be gradually changed. By setting the inversion frequency band to a frequency band that is less likely to affect the perception of the phase difference of the sound between the ears (between the left and right ears), the auditory perception can be adjusted such that, for example, the high-frequency range of the frequency bands of the target sound, where the phase difference of the sound between the ears is less perceptible, can be made easier to be heard.

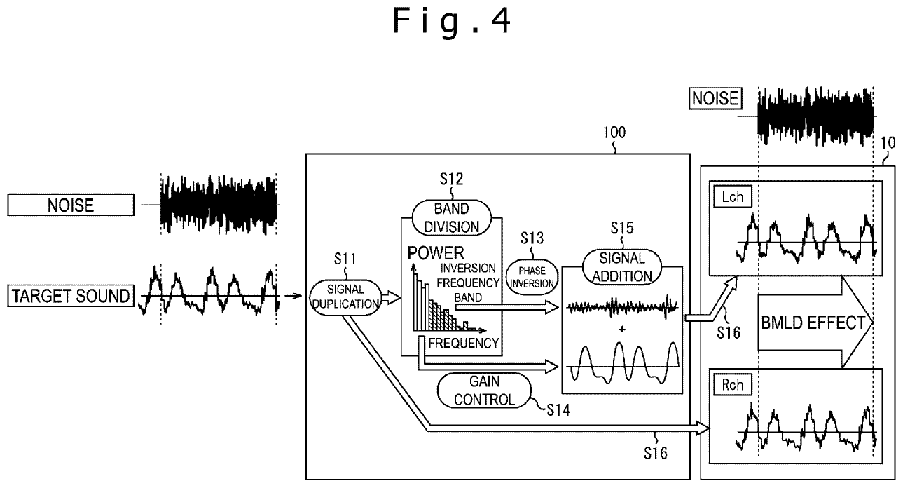

FIG. 4 is a diagram illustrating an example (overview) of a signal processing method according to the present embodiment of the present disclosure. As illustrated in FIG. 4, a playback device 100 according to the present embodiment is a processing unit that processes an audio signal to be output from an audio output device 10. The playback device 100 duplicates a target sound (monaural signal) played back in noisy environments (step S11). Target sound may be any sound, such as music or voice. In the case where the target sound is a stereo signal, the duplication processing is omitted.

When the specified volume is greater than the threshold Vth, the playback device 100 sets one of the target sound (original audio signal) and a duplicated sound (duplicated signal) obtained by duplicating the target sound as the processing target sound, sets a part of the band of the processing target as the inversion frequency band to be phase-inverted, and sets the remaining band as the non-inversion frequency band that is not to be phase-inverted (step S12).

The playback device 100 executes frequency analysis on one of the original audio signal and the duplicated signal (hereinafter collectively referred to as “audio signal”), and divides the audio signal in the frequency domain. More specifically, the playback device 100 divides the signal into an inversion frequency band and a non-inversion frequency on the basis of the frequency characteristics of the audio signal obtained through the frequency analysis.

In the case of a particular person's voice or a sound of a specific musical instrument, the inversion frequency band may be set to a unique value for each individual or each instrument by, for example, analyzing the power distribution of the frequencies in advance. The inversion frequency band may also change from moment to moment in accordance with the frequency distribution.

The playback device 100 may determine the inversion frequency band of the target sound by utilizing the frequency dependence of BMLD, as described above, for example. Note that while FIG. 4 illustrates an example of frequency characteristics of the target sound, the frequency components contained in the target sound are not limited to the example illustrated in FIG. 4, and even when the target sound includes any frequency components, the inversion frequency band of the target sound can be determined in the same manner by utilizing the frequency dependence of BMLD. The setting of these inversion frequency bands will be described later.

The playback device 100 inverts the phase of a first audio signal belonging to the inversion frequency band within the band of the audio signal (step S13), thereby generating an inverted signal. In addition, the playback device 100 controls the gain such that a second audio signal belonging to the non-inversion frequency band within the band of the audio signal has a physical sound pressure in accordance with the specified volume (step S14).

The playback device 100 adds the inverted signal and the second audio signal belonging to the non-inversion frequency band within the band of the audio signal (step S15), thereby generating an added signal. In this manner, the playback device 100 partially provides the target sound with the BMLD effect.

The playback device 100 outputs, to the audio output device 10, the added signal generated at step S15 and the duplicated signal in a synchronizing manner (step S16). Note that in FIG. 4, the duplicated target sound is illustrated as not being band-divided; however, the duplicated target sound may be subjected to band division and addition as described later.

In this manner, the playback device 100 according to the embodiment of the present disclosure can vary the effect of BMLD while providing the listener with a natural auditory sensation by dynamically changing the inversion frequency band in accordance with the specified volume, and allow the listener to listen at a desired volume without causing imbalance between the sound in the inversion frequency band and the sound in the non-inversion frequency band.

### Volume Switching Setting

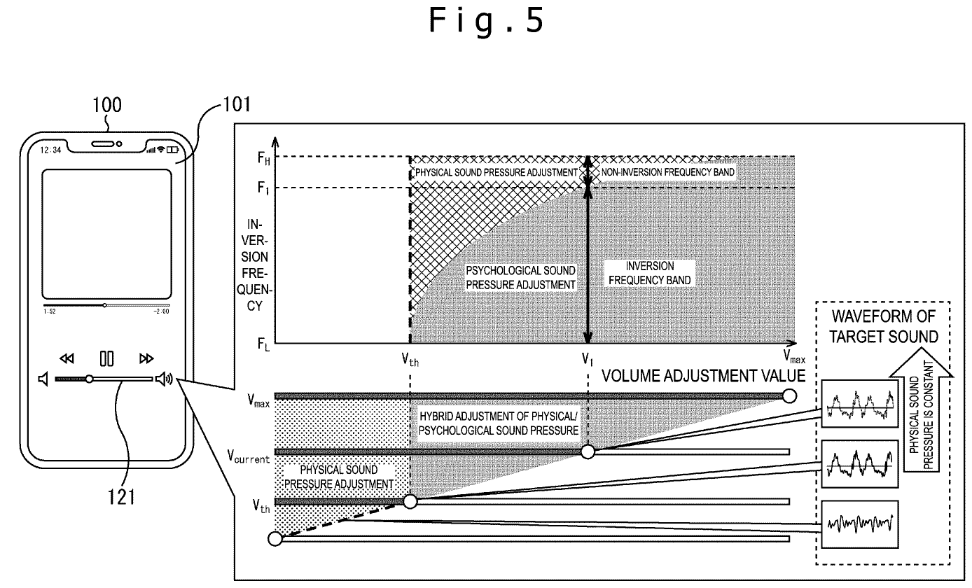

With reference to FIG. 5, a case is described below in which the user specifies the volume using a user interface (UI) displayed on the playback device 100, and the psychological sound pressure adjustment is performed in accordance with the specified volume.

The left diagram of FIG. 5 is a diagram illustrating a UI displayed on a display unit 101 of the playback device 100. The playback device 100 illustrated in FIG. 5 includes the display unit 101, and the display unit 101 includes a touch panel. On the display unit 101, a volume adjustment operation section 121 for adjusting the volume is displayed.

The volume adjustment operation section 121 is composed of a slider and a knob, and configured such that the desired volume can be set by moving the knob. As the knob on the slider of the volume adjustment operation section 121 goes to the right in the drawing, the volume is set to a larger volume.

The right diagram of FIG. 5 is a diagram for describing a relationship between the volume (specified volume) set by the user operating the volume adjustment operation section 121 and the sound pressure adjustment, and a relationship between the specified volume and the inversion frequency band in the sound pressure adjustment. The physical sound pressure adjustment is performed when the specified volume is from 0 to the threshold Vth.

The physical sound pressure adjustment refers to an adjustment of physically amplifying or attenuating the waveform of the audio signal itself. The speaker included in the earphones includes a diaphragm, and as the volume increases, the vibration of the diaphragm also increases. In the physical sound pressure adjustment, the volume (sound pressure) is adjusted by changing the width of the vibration of the diaphragm. In the physical sound pressure adjustment, the volume is adjusted by adjusting the magnitude of the amplitude of the waveform of the audio signal.

When the specified volume is set to a value equal to or greater than the threshold Vth, the physical sound pressure adjustment and the psychological sound pressure adjustment are started. In the psychological sound pressure adjustment, the volume is adjusted such that the maximum amplitude of the waveform of the audio signal is not changed. The frequency band for performing the psychological sound pressure adjustment is set in accordance with the specified volume. The graph shown in the upper right diagram of FIG. 5 is a graph showing a variation in the inversion frequency band in the psychological sound pressure adjustment, and the horizontal axis indicates the volume adjustment value, and the vertical axis indicates the inversion frequency band.

When the volume adjustment value is in the range from the threshold Vth (volume adjustment value Vth) to the maximum volume adjustment value (volume adjustment value Vmax), the psychological sound pressure adjustment is performed, and as the volume adjustment value gradually increases from the volume adjustment value Vth to the volume adjustment value Vmax, the frequency band of the inversion frequency is widened in accordance with the change. At the volume adjustment value Vth, the inversion frequency band is set to a part on a low frequency FL (the lowest frequency among the frequencies set as the inversion frequency band) side, but the frequency band is gradually widened, and at the volume adjustment value V1, the inversion frequency band is widened to the range from the low frequency FL to a frequency F1.

Further, at the volume adjustment value Vmax, the range from a frequency FH (the highest frequency among the frequencies set as the inversion frequency band) to the frequency FL is set to the inversion frequency band.

The psychological sound pressure adjustment is performed for the audio signal in the inversion frequency band, whereas the physical sound pressure adjustment is performed for the audio signal in the non-inversion frequency band.

The psychological sound pressure can be adjusted in accordance with the width of the inversion frequency band. In the example shown in FIG. 5, the sound pressure is physically gradually increased by the physical sound pressure adjustment in the range from the volume adjustment value 0 to the threshold Vth, whereas the sound pressure is psychologically gradually increased by the psychological sound pressure adjustment in the range from the threshold Vth to the maximum value Vmax.

In the case where the sound pressure is psychologically gradually increased for the audio signal in the inversion frequency band by the psychological sound pressure adjustment in the range from the threshold Vth to the maximum value Vmax, whereas the sound pressure is not increased for the audio signal in the non-inversion frequency band, the sound pressures of the audio signal in the inversion frequency band and the audio signal in the non-inversion frequency band differ, which may result in, for example, a state in which the audio signal in the inversion frequency band sounds louder whereas the audio signal in the non-inversion frequency band is less audible, thereby causing differences in perceived sound depending on the frequency band.

In the range from the threshold Vth to the maximum value Vmax, processing is performed in which the sound pressure is psychologically gradually increased by the psychological sound pressure adjustment for the audio signal in the inversion frequency band, whereas the sound pressure is physically gradually increased by the physical sound pressure adjustment for the audio signal in the non-inversion frequency band. By performing the psychological sound pressure adjustment and the physical sound pressure adjustment, adjustment to the same sound pressure is performed for the audio signal of the entire frequency band, thereby adjusting the sound pressure so as not to cause differences in perceived sound depending on the frequency band.

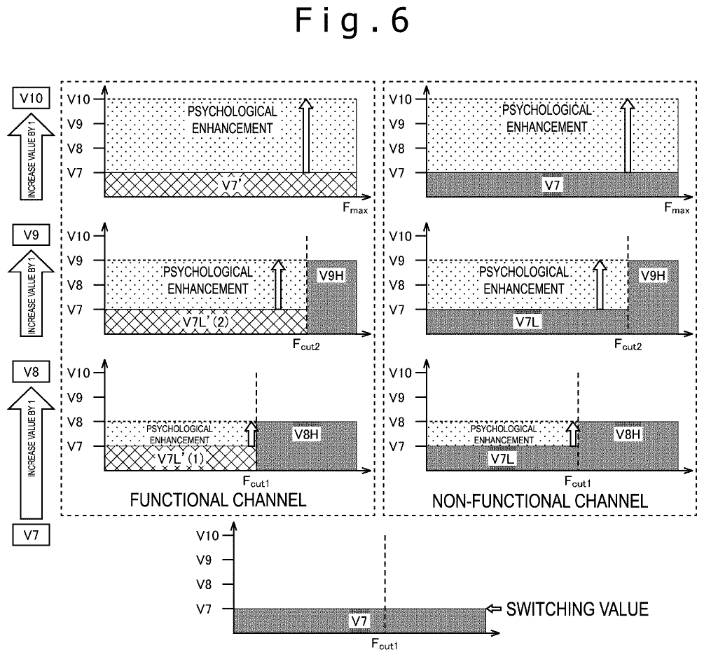

Further, with reference to FIG. 6, the sound pressure adjustment using the psychological sound pressure adjustment and the physical sound pressure adjustment is described in more detail.

The example shown in FIG. 6 is a case where the specified volume that can be specified by the user is volume V0 to volume V10, and the psychological sound pressure adjustment is started from volume V7 (case where the threshold Vth is set to volume V7).

FIG. 6 shows a case where three switching frequencies, namely, a switching frequency Fcut1, a switching frequency Fcut2, and a switching frequency Fmax are set as the boundary frequency between the inversion frequency band and the non-inversion frequency band.

When an audio signal of a target sound is inverted, and the psychological sound pressure adjustment is performed with the frequency range from 0 to Fcut1 (the following description assumes that the range starts from 0, but the low-frequency side may start from a predetermined frequency, not from 0) set as an inversion frequency band Fcut1, the volume level is increased by one level.

When an audio signal of a target sound is inverted, and the psychological sound pressure adjustment is performed with the frequency range from 0 to Fcut2 set to the inversion frequency Fcut2, the volume level is increased by two levels. When an audio signal of a target sound is inverted, and the psychological sound pressure adjustment is performed with the frequency range from 0 to Fmax set to the inversion frequency band Fmax, the volume level is increased by three levels. The following describes an example in a case in which the switching frequency Fcut1 and the switching frequency Fcut2 are set as the frequency where the volume level can be increased in the above-described manner.

When the specified volume is volume V0 to V7, the control is performed such that the specified volume is set by the physical sound pressure adjustment. When volume V8 is specified as the specified volume, not only the physical sound pressure adjustment, but also the psychological sound pressure adjustment is started. When the psychological sound pressure adjustment is started, different sound pressure adjustments are performed in the functional channel and the non-functional channel, and therefore the following describes the functional channel and the non-functional channel separately.

In the functional channel, to set the volume to volume V8, the psychological sound pressure adjustment is performed in the inversion frequency band, whereas the physical sound pressure adjustment is performed in the non-inversion frequency band. The switching frequency for the case where the volume V7 is specified is the switching frequency Fcut1, and therefore, the inversion frequency band is set to the range from 0 to Fcut1. For the audio signal in the set inversion frequency band ranging from 0 to Fcut1, the physical sound pressure adjustment (gain adjustment) is performed up to volume V7, and the audio signal corresponding to the volume V7 is inverted, thereby performing psychological volume enhancement, and generating an audio signal corresponding to the volume V8.

In the functional channel, an audio signal V7L′(1) obtained by inverting the audio signal V7L in the inversion frequency band set to the volume V7 level by the physical sound pressure adjustment is generated. The dash symbol in the audio signal V7L′ indicates that the signal has been phase-inverted, and 7L indicates that it is a low-frequency (inversion frequency band) signal that has been adjusted to correspond to the volume level V7 by the physical sound pressure adjustment.

Since inverting the audio signal in the inversion frequency band Fcut1 results in the volume enhancement equivalent to one level, the audio signal V7L′(1) becomes an audio signal equivalent to the volume V8.

For the audio signal in the frequency band equal to or greater than the frequency Fcut1, an audio signal V8H at the volume V8 level is generated by the physical sound pressure adjustment (gain adjustment).

Also in the non-functional channel, to set the volume to the volume V8, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V7, thereby generating the audio signal V7L corresponding to the volume V7. The inversion of the audio signal on the functional channel side results in psychological enhancement of one level, and as a result, the audio signal V7L corresponding to the volume V8 is obtained.

Also on the non-functional channel side, for the audio signal in the frequency band which is equal to or greater than the frequency Fcut1, an audio signal V8H at the volume V8 level is generated by the physical sound pressure adjustment.

On the functional channel side, the psychological sound pressure adjustment is performed by adjusting the sound pressure (gain adjustment) through the physical sound pressure adjustment to a level reduced by the amount of the psychological enhancement resulting from the psychological sound pressure adjustment, and inverting that audio signal. On the non-functional channel side, the processing of inverting the phase of the audio signal is not performed, and only the processing related to the physical sound pressure adjustment (gain adjustment) is executed.

On the functional channel side, processing is executed so as to achieve the specified volume by the psychological sound pressure adjustment, whereas on the non-functional channel side, processing is executed so as to achieve the specified volume by the physical sound pressure adjustment. In this manner, in the case where there are two channels, namely the functional channel and the non-functional channel, the psychological sound pressure adjustment is performed on one side, whereas the physical sound pressure adjustment is performed on the other side, thereby performing the psychological sound pressure adjustment and the physical sound pressure adjustment in different channels.

When volume V9 is specified as the specified volume, the psychological sound pressure adjustment is performed in the inversion frequency band, whereas the physical sound pressure adjustment is performed in the non-inversion frequency band in the functional channel. The switching frequency for a case where the volume V9 is specified is the switching frequency Fcut2, and therefore, the inversion frequency band is switched to the range from 0 to Fcut2.

In the functional channel, for the audio signal in the inversion frequency band, an audio signal V7L′(2) obtained by inverting the audio signal V7L set to the volume V7 level by the physical sound pressure adjustment is generated. Since inverting the audio signal in the frequency band up to the frequency Fcut2 results in the volume enhancement equivalent to two levels, the audio signal V7L′(2) becomes an audio signal equivalent to the volume V9.

For the audio signal in the frequency band equal to or greater than the frequency Fcut2, an audio signal V9H at the volume V9 level is generated by the physical sound pressure adjustment.

Also in the non-functional channel, to set the volume to the volume V9, the psychological sound pressure adjustment is performed in the inversion frequency band, whereas the physical sound pressure adjustment is performed in the non-inversion frequency band. For the audio signal in the inversion frequency band Fcut2, the physical sound pressure adjustment (gain adjustment) is performed up to the volume V7, thereby generating the audio signal V7L corresponding to the volume V7. The inversion of the audio signal on the functional channel side results in psychological enhancement of two levels, and as a result, the audio signal V7L corresponding to the volume V9 is obtained.

Also on the non-functional channel side, for the audio signal in the frequency band equal to or greater than the frequency Fcut2, an audio signal V9H at the volume V9 level is generated by the physical sound pressure adjustment.

When the volume V10 is specified as the specified volume, in the functional channel, to set the volume to the volume V10, the psychological sound pressure adjustment is performed in the inversion frequency band, whereas the physical sound pressure adjustment is performed in the non-inversion frequency band. The switching frequency for a case where the volume V10 is specified is the switching frequency Fmax, and therefore, the inversion frequency band is switched to the range from 0 to Fmax.

In the functional channel, for the audio signal in the inversion frequency band, an audio signal V7L′ obtained by inverting the audio signal V7L set to the volume V7 level by the physical sound pressure adjustment is generated. Since inverting the audio signal in the frequency band up to the frequency Fmax results in the volume enhancement equivalent to three levels, the audio signal V7L′ becomes an audio signal equivalent to the volume V10.

In the case where the specified volume is the volume V10, there is no audio signal of the frequency band equal to or greater than the frequency Fmax, and therefore, no audio signal is generated by the physical sound pressure adjustment, and the audio signal is psychologically enhanced across the entire frequency band.

Also in the non-functional channel, to set the volume to the volume V10, the psychological sound pressure adjustment is performed across the entire frequency band. For the audio signal in the inversion frequency band, the physical sound pressure adjustment (gain adjustment) is performed up to the volume V7, thereby generating the audio signal V7 corresponding to the volume V7. The inversion of the audio signal on the functional channel side results in psychological enhancement equivalent to three levels, and as a result, the audio signal V7 corresponding to the volume V10 is obtained.

In the case where an audio signal equivalent to the volume V10 is generated, the psychological sound pressure adjustment is executed on the functional channel side, whereas the physical sound pressure adjustment is executed on the non-functional channel side. In this manner, in the case where there are two channels, namely the functional channel and the non-functional channel, the psychological sound pressure adjustment is performed on one side, whereas the physical sound pressure adjustment is performed on the other side, thereby performing the psychological sound pressure adjustment and the physical sound pressure adjustment in different channels.

In this manner, even in the case where the specified volume is equal to or greater than the volume V7, the sound pressure adjustment by the physical sound pressure adjustment is performed only up to the sound pressure corresponding to the volume V7. Continuously listening at a relatively high volume may lead to the deterioration of auditory function, but the present technology suppresses the sound pressure due to the physical sound pressure adjustment even when the user listens to sound at a relatively high volume for an extended period, and it is thus possible to prevent the deterioration of auditory function, vary the effect of BMLD while providing the listener with a natural auditory sensation, and allow the listener to listen at a desired volume without causing frequency imbalance between the sound in the inversion frequency band and the sound in the non-inversion frequency band.

### Volume and Sound Pressure

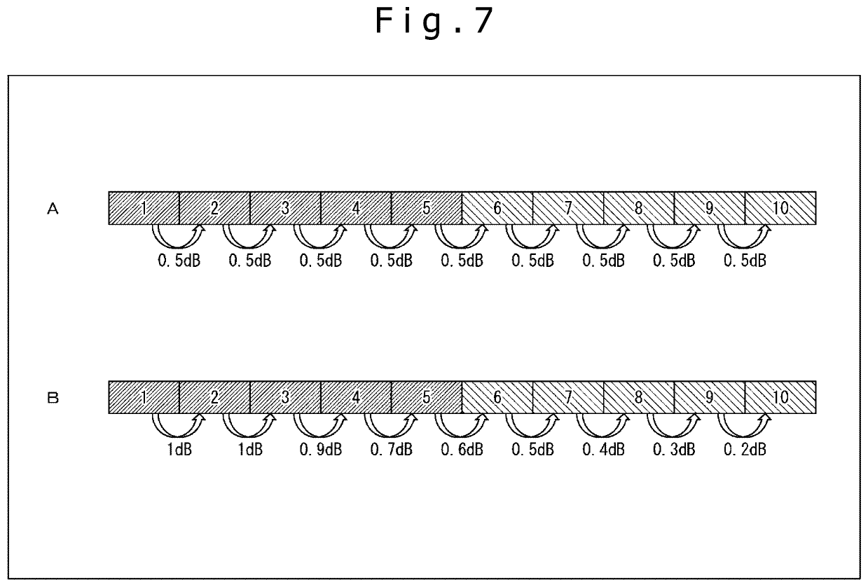

For example, in the case where the volume adjustment value is designed with steps ranging from 0 to 100, one step of the volume adjustment value does not necessarily correspond to 1 dB of sound pressure, and therefore, the volume adjustment value is converted into units of dB. The physical sound pressure adjustment and the psychological sound pressure adjustment are performed such that the volume specified by the user is achieved by the physical sound pressure adjustment or the psychological sound pressure adjustment. This point is described in detail below with reference to FIG. 7.

A in FIG. 7 and B in FIG. 7 are diagrams illustrating an example in a case where the volume adjustment value can be set in 10 steps from 0 to 10, and diagrams for describing a relationship between the volume adjustment value and the amplification value converted into units of dB in a case where the volume is adjusted by the physical sound pressure adjustment when the volume adjustment value is from step 1 to step 5, whereas the volume is adjusted by the psychological sound pressure adjustment when the volume adjustment value is from step 6 to step 10.

A in FIG. 7 illustrates a case where when the volume adjustment value is increased by one step, the volume is increased by 0.5 dB. For example, when the volume adjustment value is changed from step 1 to step 2, the volume is increased by 0.5 dB by the physical sound pressure adjustment. For example, when the volume adjustment value is changed from step 6 to step 7, the volume is increased by 0.5 dB by the psychological sound pressure adjustment.

In the example illustrated in A in FIG. 7, the volume adjustment value is designed with steps ranging from 1 to 10, and the volume is adjusted such that one step of the volume adjustment value corresponds to a sound pressure of 0.5 dB. In this manner, the amount of increase in the volume adjustment value and the amount of increase in the volume converted into units of dB can be set to be proportionally amplified.

Human perception is nonlinear, and therefore, in a case where the volume is set to be linearly increased by 0.5 dB when the volume adjustment value is increased by one step as in the example illustrated in A in FIG. 7, the user may not perceive the volume as being amplified linearly. In view of this, as illustrated in B in FIG. 7, the volume may be nonlinearly adjusted.

B in FIG. 7 illustrates a case where when the volume adjustment value is increased by one step, the volume is adjusted by dB corresponding to one step perceived by the user. For example, this drawing illustrates an example in which when the user has a perceptual characteristic in which differences in volume are less noticeable at lower volumes and more noticeable at higher volumes, the change in the amplification value converted into dB is greater when the volume adjustment value is small, and smaller when the volume adjustment value is large.

For example, when the volume adjustment value is changed from step 1 to step 2, the volume is increased by the physical sound pressure adjustment by 1 dB. When the volume adjustment value is changed from step 2 to step 3, the volume is increased by the physical sound pressure adjustment by 1 dB. When the volume adjustment value is changed from step 3 to step 4, the volume is increased by the physical sound pressure adjustment by 0.9 dB. When the volume adjustment value is changed from step 4 to step 5, the volume is increased by the physical sound pressure adjustment by 0.7 dB. When the volume adjustment value is changed from step 5 to step 6, the volume is increased by the physical sound pressure adjustment by 0.6 dB.

When the volume adjustment value is changed from step 6 to step 7, the volume is increased by the psychological sound pressure adjustment by 0.5 dB. When the volume adjustment value is changed from step 7 to step 8, the volume is increased by the psychological sound pressure adjustment by 0.4 dB. When the volume adjustment value is changed from step 8 to step 9, the volume is increased by the psychological sound pressure adjustment by 0.3 dB. When the volume adjustment value is changed from step 9 to step 10, the volume is increased by the psychological sound pressure adjustment by 0.2 dB.

In the example illustrated in B in FIG. 7, the volume adjustment value is designed with steps ranging from 1 to 10, and the volume is adjusted in such a manner that the amount of amplification per one step of the volume adjustment value is nonlinear. In this manner, the amount of increase in the volume adjustment value and the amount of increase in the volume converted into units of dB may be set to be nonlinearly amplified.

The graph described below that illustrates a relationship between the volume adjustment value and the inversion frequency band may be a graph in which the frequency band is designed such that when the user specifies an increase in volume by one step, the user can perceive the increase in volume by one step, in the psychological sound pressure adjustment as described with reference to B in FIG. 7. Such a graph is described in detail below.

### Relationship between Volume Adjustment Value and Inversion Frequency Band

A relationship between the volume adjustment value and the inversion frequency band is described below in more detail. The graph of FIG. 5 shows an example of the relationship between the volume adjustment value and the inversion frequency. The graph of FIG. 5 showing the relationship between the volume adjustment value and the inversion frequency is composed of two elements, namely a variation pattern and a curve shape of the graph.

The variation pattern refers to the pattern indicating from which frequency the inversion starts and how the band is widened in accordance with changes in the volume adjustment value. The curve shape of the graph refers to the shape of the curve in the graph of the volume adjustment value and the inversion frequency, and corresponds to the shape of the boundary line between the inversion frequency band and the non-inversion frequency band.

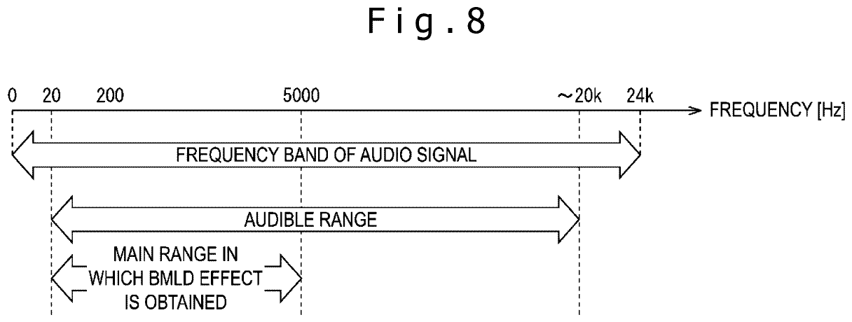

In the following description, the range treated as inversion frequency is described with reference to FIG. 8. The range treated as inversion frequency may be, for example, the frequency band of the audio signal. The graph described below may be created and processed for the frequencies within the frequency band of the audio signal. The frequency band of the audio signal may be, for example, from 0 Hz to 24 kHz. In a case where the inversion frequency is set from 0 Hz to 24 kHz, the minimum value of the inversion frequency is treated as 0 Hz, and the maximum value is treated as 24 kHz.

The range treated as inversion frequency may be, for example, the audible range. Since the audible range differs among users, the audible range may be measured for each user, and set on the basis of the measurement. The graph described later may be created and processed for the frequencies within the set audible range. The audible range may be, for example, from 20 Hz to 20 kHz. In a case where inversion frequency is set from 20 Hz to 20 kHz, the minimum value of the inversion frequency is treated as 20 Hz, and the maximum value is treated as 20 kHz.

The range treated as the inversion frequency may be, for example, the main range in which the BLMD effect is obtained. The graph described later may be created and processed for the frequencies within the main range in which the BLMD effect is obtained. The main range in which the BLMD effect is obtained may be, for example, from 20 Hz to 5000 Hz. In a case where the inversion frequency is set from 20 Hz to 5000 kHz, the minimum value of the inversion frequency is treated as 20 Hz, and the maximum value is treated as 5000 kHz.

Three ranges are described above as examples of the range treated as the inversion frequency; however, other ranges are also applicable in the present technology.

The graph described below may be created and processed using any one of the three ranges exemplified above, or the graph described below may be created and processed using a combination of two or three ranges.

Note that in the above and following descriptions, the numerical value is merely an example, and is not limitative.

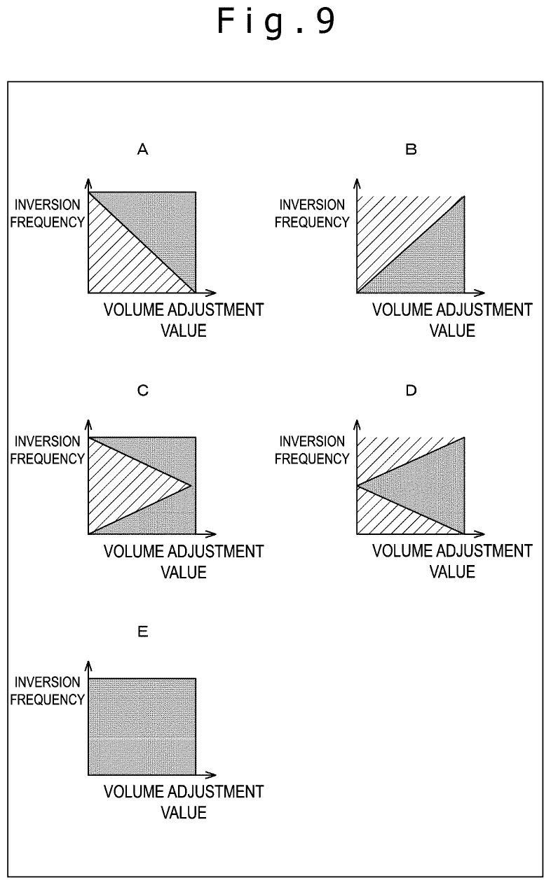

FIG. 9 shows an example of a variation pattern. In each variation pattern shown in FIG. 9, the horizontal axis indicates the volume adjustment value, and the vertical axis indicates the inversion frequency, with the origin of the volume adjustment value corresponding to the threshold value Vth. In the graphs shown in FIGS. 9 to 14, the solid region represents the inversion frequency band, which is the frequency band where the psychological sound pressure adjustment is performed, and the hatched region represents the non-inversion frequency band, which is the frequency band where the physical sound pressure adjustment is performed.

The variation pattern A shown in A of FIG. 9 is a pattern in which, as the volume adjustment value increases, the inversion frequency band is gradually widened from the high-frequency side to the low-frequency side, and the frequency band in which the psychological sound pressure adjustment is performed is gradually widened. In other words, the variation pattern A is a pattern in which, as the volume adjustment value increases, the non-inversion frequency band is gradually narrowed from the high-frequency side to the low-frequency side, and the frequency band in which the physical sound pressure adjustment is performed is gradually narrowed.

The variation pattern B shown in B of FIG. 9 is a pattern in which, as the volume adjustment value increases, the inversion frequency band is gradually widened from the low-frequency side to the high-frequency side, and the frequency band in which the psychological sound pressure adjustment is performed is gradually widened. In other words, the variation pattern B is a pattern in which, as the volume adjustment value increases, the non-inversion frequency band is gradually narrowed from the low-frequency side to the high-frequency side, and the frequency band in which the physical sound pressure adjustment is performed is gradually narrowed.

The variation pattern C shown in C of FIG. 9 is a pattern in which, as the volume adjustment value increases, the inversion frequency band is gradually widened from the high-frequency side to the low-frequency side and from the low-frequency side to the high-frequency side, and the frequency band in which the psychological sound pressure adjustment is performed is gradually widened. In other words, the variation pattern C is a pattern in which, as the volume adjustment value increases, the non-inversion frequency band is gradually narrowed from the high-frequency side to the low-frequency side and from the low-frequency side to the high-frequency side, and the frequency band in which the physical sound pressure adjustment is performed is gradually narrowed.

The variation pattern D shown in D of FIG. 9 is a pattern in which, as the volume adjustment value increases, the inversion frequency band is gradually widened to the low-frequency side and the high-frequency side from a frequency positioned approximately at the midpoint between the maximum frequency and the minimum frequency set as the inversion frequency, and the frequency band in which the psychological sound pressure adjustment is performed is gradually widened. In other words, the variation pattern D is a pattern in which, as the volume adjustment value increases, the non-inversion frequency band is gradually narrowed toward the low-frequency side and the high-frequency side from a frequency positioned approximately at the midpoint between the maximum frequency and the minimum frequency set as the non-inversion frequency, and the frequency band in which the physical sound pressure adjustment is performed is gradually narrowed.

The variation pattern E shown in E of FIG. 9 is a pattern in which the inversion frequency band is constant regardless of the increase in volume adjustment value.

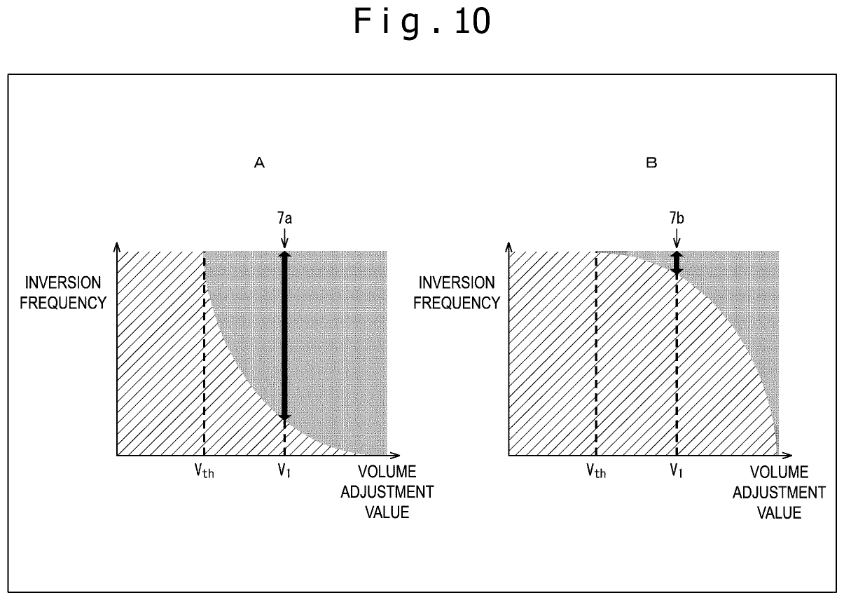

The shapes of the boundary line between the inversion frequency band and the non-inversion frequency band of each of the patterns A to E shown in FIG. 9 described above are straight lines. The shape of the boundary line between the inversion frequency band and the non-inversion frequency band may have a curve shape as shown in FIG. 10 in addition to the straight line shapes.

A curve pattern A shown in A in FIG. 10 has a shape protruding downward as the shape of the boundary line between the inversion frequency band and the non-inversion frequency band. The curve pattern A shown in A in FIG. 10 is a pattern in which, as the volume adjustment value increases, the inversion frequency band is steeply widened in the vicinity of a low volume, such as in the vicinity of the threshold Vth. For example, in a case of the volume adjustment value V1, the inversion frequency band is a band 7a.

A curve pattern B shown in B in FIG. 10 has a shape protruding upward as the shape of the boundary line between the inversion frequency band and the non-inversion frequency band. The curve pattern B shown in B in FIG. 10 is a pattern in which, as the volume adjustment value increases, the inversion frequency band is gently widened in the vicinity of a low volume, such as in the vicinity of the threshold Vth. For example, in the case of the volume adjustment value V1, the inversion frequency band is a band 7b.

In the case where the volume adjustment value V1 in the curve pattern A shown in A in FIG. 10 and the volume adjustment value V1 in the curve pattern B shown in B in FIG. 10 are the same value, and the inversion frequency band 7a and the inversion frequency band 7b are compared with each other, the relationship of the inversion frequency band 7a>the inversion frequency band 7b holds.

In this manner, the width of the inversion frequency band at a predetermined volume adjustment value can also be designed to differ by using curve patterns. As an example, a curve pattern is designed so as to set the inversion frequency band in which the volume adjustment value corresponding to one step is 1 dB.

The variation pattern shown in FIG. 9 and the curve pattern shown in FIG. 10 are merely examples, and are not limitative.

The combination of the variation patterns A to E shown in FIG. 9 and the curve patterns A and B shown in FIG. 10 can be freely designed. It is possible to use an inversion frequency band pattern obtained by combining any one of the variation patterns A to E shown in FIG. 9 and the curve pattern A or B shown in FIG. 10. The combination of the variation pattern and the curve pattern is merely an example, and is not limitative.

It is possible to use an inversion frequency band pattern obtained by combining a plurality of patterns among the variation patterns A to E shown in FIG. 9.

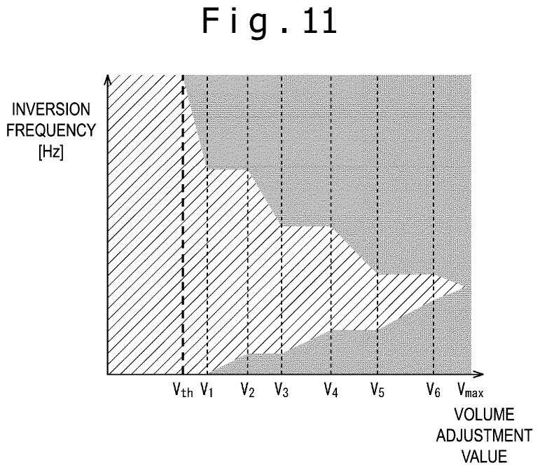

It is possible to use an inversion frequency band pattern obtained by combining a variation pattern obtained by combining a plurality of patterns among the variation patterns A to E shown in FIG. 9, and the curve pattern A and/or B shown in FIG. 10. An example thereof is shown in FIG. 11. The inversion frequency band pattern shown in FIG. 11 is a pattern obtained by combining a plurality of variation patterns, namely, the variation pattern A, the variation pattern B, the variation pattern C, and the variation pattern E.

In the range from the volume adjustment value Vth to the volume adjustment value V1, the variation pattern A is applied such that the inversion frequency band is set to be gradually widened from the high-frequency side as the volume increases. In the range from the volume adjustment value V1 to the volume adjustment value V2, the variation pattern E is applied on the high-frequency side such that the inversion frequency band is maintained on the high-frequency side, whereas the variation pattern B is applied on the low-frequency side such that the inversion frequency band is set to be gradually widened from the low-frequency side as the volume increases.

In the range from the volume adjustment value V2 to the volume adjustment value V3, the variation pattern A is applied on the high-frequency side such that the inversion frequency band is set to be gradually widened from the high-frequency side as the volume increases, whereas the variation pattern E is applied on the low-frequency side such that the inversion frequency band is set to be maintained on the low-frequency side.

In the range from the volume adjustment value V3 to the volume adjustment value V4, the variation pattern E is applied on the high-frequency side such that the inversion frequency band is maintained on the high-frequency side, whereas the variation pattern B is applied on the low-frequency side such that the inversion frequency band is set to be gradually widened from the low-frequency side as the volume increases.

In the range from the volume adjustment value V4 to the volume adjustment value V5, the variation pattern A is applied on the high-frequency side such that the inversion frequency band is set to be gradually widened from the high-frequency side as the volume increases, whereas the variation pattern E is applied on the low-frequency side such that the inversion frequency band is set to be maintained on the low-frequency side.

In the range from the volume adjustment value V5 to the volume adjustment value V6, the variation pattern E is applied on the high-frequency side such that the inversion frequency band is maintained on the high-frequency side, whereas the variation pattern B is applied on the low-frequency side such that the inversion frequency band is set to be gradually widened from the low-frequency side as the volume increases.

In the range from the volume adjustment value V6 to the volume adjustment value Vmax, the variation pattern C is applied such that the inversion frequency band is set to be gradually widened from the high-frequency side as the volume increases, and gradually widened also from the low-frequency side.

As described above, a step-like pattern obtained by using two or more variation patterns multiple times in different volume adjustment ranges may be applied. Although FIG. 11 shows an example in which only linear shapes are used for the curve shape, the curve shapes of the variation patterns may differ for each volume adjustment range.

The graphs of relationships between the volume adjustment value and the inversion frequency shown in FIGS. 9, 10, and 11 are stored as data in the playback device 100 in the form of a table, for example. When performing the psychological sound pressure adjustment, the playback device 100 executes processing related to the psychological sound pressure adjustment with reference to the stored table.

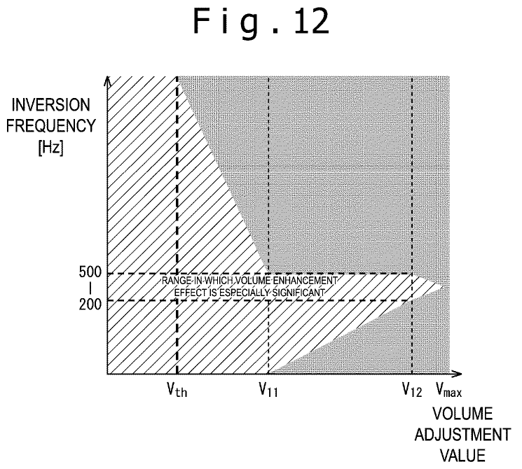

Considering the frequency characteristics of BMLD with reference to FIG. 2, it is possible to achieve a design in which the change in the psychological sound pressure for each step of the volume adjustment value is uniform by combining the variation patterns and curves in consideration of the following points. FIGS. 12 to 14 are other examples of graphs (tables) showing a relationship between the volume adjustment value and the inversion frequency.

The variation patterns of the graphs shown in FIGS. 12 to 14 are designed to be changed toward the band in the vicinity of the maximum BMLD frequency, or widened from the band in the vicinity of the maximum BMLD frequency, as the volume adjustment value increases.

The maximum BMLD frequency may differ depending on the frequency distribution of the target sound, and the frequency to which the maximum BMLD frequency is set can be appropriately determined on the basis of the frequency distribution of the target sound. In FIGS. 12 to 14, a case is described, as an example, in which the band in the vicinity of the maximum BMLD frequency (the maximum BMLD frequency band) is set from 200 Hz to 500 Hz.

The following describes an example in a case in which the curve is designed such that in the frequency band in the vicinity of the maximum BMLD frequency, the inversion frequency is taken little by little as the volume adjustment value increases, that is, the curve is designed to gently change, whereas in the high-frequency band, the inversion frequency is widely taken as the volume adjustment value increases, that is, the curve is designed to steeply change.

FIG. 12 is a graph of a case where the psychological sound pressure adjustment is performed such that the frequency band where the BMLD effect is strongly obtained (the maximum BMLD frequency band) is not inverted until the end. In other words, FIG. 12 is a graph of a case where the physical sound pressure adjustment is performed until the end for the frequency band where the BMLD effect is strongly obtained (the maximum BMLD frequency band).

With reference to FIG. 12, in the range from the volume adjustment value Vth to the volume adjustment value V11, the variation pattern A is applied such that the inversion frequency band is set to be gradually widened from the high-frequency side as the volume increases. At the volume adjustment value V11, the range from the maximum frequency to the frequency of 500 Hz in the audio signal is set as the inversion frequency band, for example.

In the range from the volume adjustment value V11 to the volume adjustment value V12, the variation pattern E is applied on the high-frequency side such that the inversion frequency band is maintained on the high-frequency side, whereas the variation pattern B is applied on the low-frequency side such that the inversion frequency band is set to be gradually widened from the low-frequency side as the volume increases. At the volume adjustment value V12, the range from the minimum frequency to the frequency of 200 Hz in the audio signal is set as the inversion frequency band, for example.

In the range from the volume adjustment value V12 to the volume adjustment value Vmax, the variation pattern C is applied such that the inversion frequency band is set to be gradually widened from the high-frequency side (in the example shown in FIG. 12, the inversion frequency band is gradually widened from 500 Hz to 350 Hz) as the volume increases, and set to be gradually widened also from the low-frequency side (in the example shown in FIG. 12, the inversion frequency band is gradually widened from 200 Hz to 350 Hz).

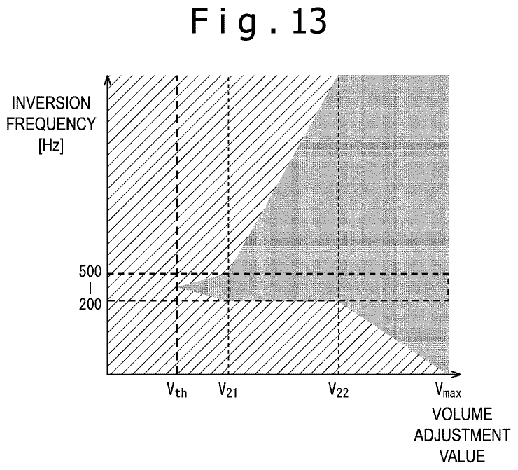

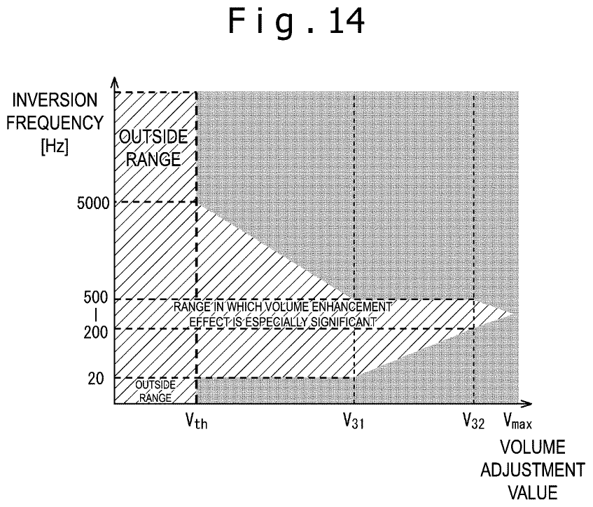

Note that while 200 Hz, 500 Hz, and 350 Hz are exemplified above, other frequencies may of course be applied. Here, the frequency in the vicinity of 200 Hz where the BMLD effect is large is used as the boundary frequency, and 350 Hz is used as an example. The same applies to FIGS. 13 and 14 described below, and the numerical value is merely an example, and is not limitative.

FIG. 13 is a graph showing a case where the psychological sound pressure adjustment is performed such that the frequency band where the BMLD effect is strongly obtained (the maximum BMLD frequency band) is inverted first. With reference to FIG. 13, in the range from the volume adjustment value Vth to the volume adjustment value V21, the variation pattern D is applied such that the inversion frequency band is set to be gradually widened from approximately 350 Hz to 200 Hz (low-frequency side) as the volume increases, and also set to be gradually widened from approximately 350 Hz to 500 Hz (high-frequency side), for example.

In the range from the volume adjustment value V21 to the volume adjustment value V22, the variation pattern B is applied such that the range is set to be gradually widened to the high-frequency side as the volume increases. At the volume adjustment value V22, the frequency range from 200 Hz to the maximum frequency set as the maximum value of the inversion frequency band is set as the inversion frequency band, for example.

In the range from the volume adjustment value V22 to the volume adjustment value Vmax, the variation pattern A is applied such that the inversion frequency band is set to be widened from the highest frequency set as the maximum value of the inversion frequency band to the minimum frequency set as the minimum value as the volume increases.

Now, FIGS. 2 and 8 are again referred to. As described above with reference to FIG. 2, the frequency band where BMLD occurs is limited. Therefore, instead of designing a graph (table) indicating the relationship between the volume adjustment value and the inversion frequency band across the entire frequency band of the target sound, it is possible to design it only within a limited frequency range, thereby reducing the design-related workload or reducing the amount of data stored as a table.

For example, as described above with reference to FIG. 8, by treating the audible range or the main range in which the BMLD effect can be obtained as the inversion frequency band, it is possible to reduce the design-related workload for a table or reduce the amount of data stored as a table. Even when the frequency band of the audio signal is set to be treated as the inversion frequency band, it is possible to reduce the design-related workload for a table or the amount of data stored as a table by handling a narrower range than that described with reference to FIG. 8.

As shown in FIG. 2, since a certain BMLD effect can be obtained up to approximately 5 kHz, it is considered that the main range in which the BMLD effect can be obtained is from 20 Hz to 5 kHz, as described with reference to FIG. 8. In consideration of this point, it is also possible to create a table such as that shown in FIG. 14.

FIG. 14 is a graph showing a case where the main range in which the BMLD effect can be obtained is taken into consideration, and when the specified volume exceeds the threshold Vth of the volume adjustment value, frequencies other than the main range in which the BMLD effect can be obtained are processed all at once as the inversion frequency band, whereas other ranges are processed by the physical sound pressure adjustment. With reference to FIG. 14, when the value exceeds the volume adjustment value Vth, the frequency band from 5000 Hz to the highest frequency of the audio signal is set as the inversion frequency band on the high-frequency side, whereas the frequency band from the minimum frequency of the audio signal to, for example, 20 Hz is set as the inversion frequency band on the low-frequency side.

On the high-frequency side ranging from the volume adjustment value Vth to the volume adjustment value V31, the variation pattern A is applied and set such that the inversion frequency band is gradually widened to the low-frequency side from the 5000 Hz side as the volume increases. At the volume adjustment value V31, the frequency range from the maximum frequency to 500 Hz is set as the inversion frequency band, for example. In the range from the volume adjustment value Vth to the volume adjustment value V31, the variation pattern E is applied on the low-frequency side such that the state where the frequency band from the minimum frequency to 20 Hz is set to the inversion frequency band is maintained.

In the range from the volume adjustment value V31 to the volume adjustment value V32, the variation pattern E is applied on the high-frequency side such that the state where the frequency band from the maximum frequency to 500 Hz is set to the inversion frequency band is maintained. In the range from the volume adjustment value V31 to the volume adjustment value V32, the variation pattern B is applied on the low-frequency side such that the inversion frequency band is set to be gradually widened to the high-frequency side from 20 Hz as the volume increases. At the volume adjustment value V32, the frequency range from the minimum frequency to 200 Hz is set as the inversion frequency band, for example.

In the range from the volume adjustment value V32 to the volume adjustment value Vmax, the variation pattern C is applied such that the inversion frequency band is set to be gradually widened from the high-frequency side (in the example shown in FIG. 14, the inversion frequency band is gradually widened to 350 Hz) as the volume increases, and set to be gradually widened also from the low-frequency side (in the example shown in FIG. 14, the inversion frequency band is gradually widened to 350 Hz).

As described above with reference to FIG. 14, by applying a pattern in which a variation pattern and a curve pattern are combined after processing the frequencies outside the main range in which the BMLD effect can be obtained all at once as the inversion frequency band, it is possible to eliminate discontinuities in the audio signal caused by phase inversion of a part of the frequencies.

The playback device 100 stores the graphs (tables) shown in FIGS. 9 to 14, and when the volume specified by the user is set to a value equal to or greater than the threshold Vth, the playback device 100 sets the inversion frequency band associated with the specified volume with reference to the table, and performs inversion processing on the signal component of the target sound within the set inversion frequency band, thereby performing the psychological sound pressure adjustment.

One or a plurality of tables may be stored in the playback device 100. In the case where a plurality of tables are stored, it is possible to adopt a configuration including a process of selecting the table to be applied in accordance with the type of target sound.

For example, when it is determined that the target sound is a human voice, the pattern D (FIG. 9) in which the frequency band of the human voice is set to the inversion frequency band is applied. For example, when it is determined that the target sound is music with strong bass, the pattern B in which the inversion frequency band is gradually widened from the low-frequency side to the high-frequency side is applied.

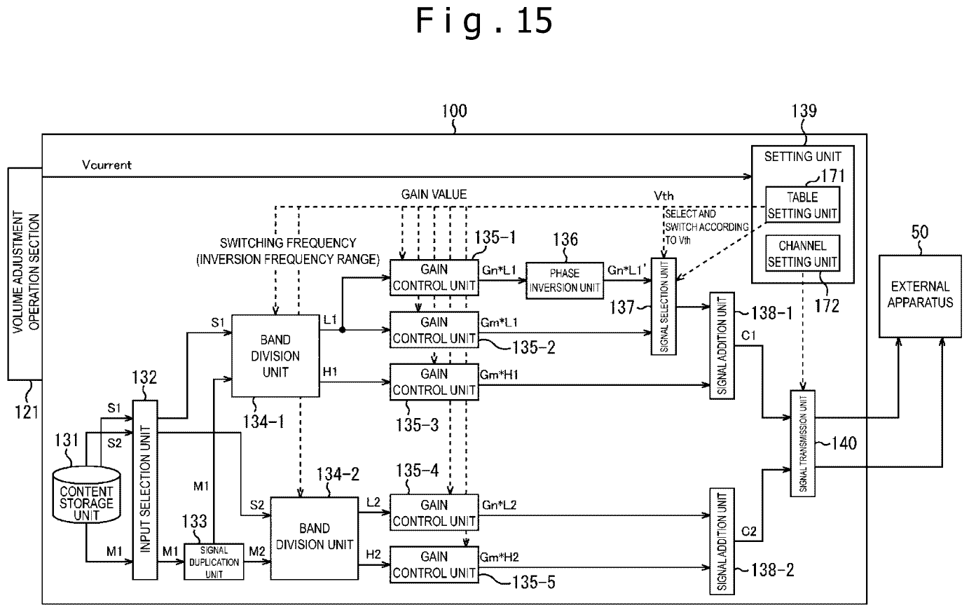

The stored table may be edited by the user. A table setting unit 171 (FIG. 15) stores a table set in advance, and/or a table set or edited by the user using a user interface (UI). The table setting unit 171 may change the inversion frequency band at any time and automatically in accordance with the characteristics of the target sound and/or the characteristics of the user. For example, in a case of a particular person's voice or a specific musical instrument, the table setting unit 171 may analyze the power distribution of the frequency in advance so that a unique graph of the volume adjustment value and the inversion frequency band is set for each person or music instrument.

The graph of the volume adjustment value and the inversion frequency band may be recommended to the user on the basis of the frequency power distribution of the audio signal, and the user may be allowed to edit it.

At the table setting unit 171, the inversion frequency band may also change from moment to moment in accordance with the frequency distribution of the target sound. The table setting unit 171 may determine the inversion frequency band of the target sound by utilizing the frequency dependence of BMLD, as described above, for example. Note that the table setting unit 171 can determine the inversion frequency band of the target sound by utilizing the frequency dependence of BMLD regardless of the frequency components contained in the target sound.

As an example of the above-described characteristics of the user, the table setting unit 171 may acquire data on the auditory characteristics of the user by, for example, measuring the auditory characteristics of the user in advance, and change the inversion frequency band at any time in accordance with that data. Here, the auditory characteristics of the user may be general or specific to the individual user (personal characteristics). The table setting unit 171 may manually receive the setting of the inversion frequency band from the user. In this case, the table setting unit 171 may be configured to provide the power distribution of the frequency to be analyzed and the value of the optimum inversion frequency band to allow the user to select or edit them. When the user is using a hearing aid and/or a sound collector, data may be acquired from the hearing test result of the user, an audiogram, and/or the like.

These operations may be performed online by a person at a remote location, not by the user themselves. For example, the service may be deployed in combination with a hearing aid. In the case of a hearing aid, after sound is collected by the hearing aid, it is necessary to perform sound source separation to separate the sound into the target sound and noise. After the sound source separation, the present technology can be combined as a volume adjustment function for the target sound.

For example, the above-described graph (table) may be configured such that a specialist at a remote location can select the table suitable for the user using a hearing aid or edit the table on behalf of the user using the hearing aid. It is also possible to expand the application to services that remotely adjust auditory perception on the basis of the hearing characteristics of the user wearing the hearing aid and their changes over time. In such use cases and the like, the adjustment processes of the graph of the volume adjustment value and the inversion frequency band may be recorded as a log, and the graph may be edited using the log.

### Configuration Example and Processing Example of Playback Device

Specific examples of the components of the playback device 100 are described below with reference to the accompanying drawings. FIG. 15 is a diagram illustrating a configuration example of the playback device 100. The playback device 100 serves as a processing unit that processes the audio signal of the sound output from an external apparatus 50, which is an audio output device such as earphones and headphones. In FIG. 15, a configuration is illustrated in which the playback device 100 is provided as a device separated from the external apparatus 50, but it is possible to adopt a configuration in which the playback device 100 is included in the processing unit in the external apparatus 50.

The playback device 100 illustrated in FIG. 15 includes the volume adjustment operation section 121, a content storage unit 131, an input selection unit 132, a signal duplication unit 133, band division units 134-1 and 134-2, gain control units 135-1 to 135-5, a phase inversion unit 136, a signal selection unit 137, signal addition units 138-1 and 138-2, a setting unit 139, and a signal transmission unit 140. The setting unit 139 includes the table setting unit 171 and a channel setting unit 172.

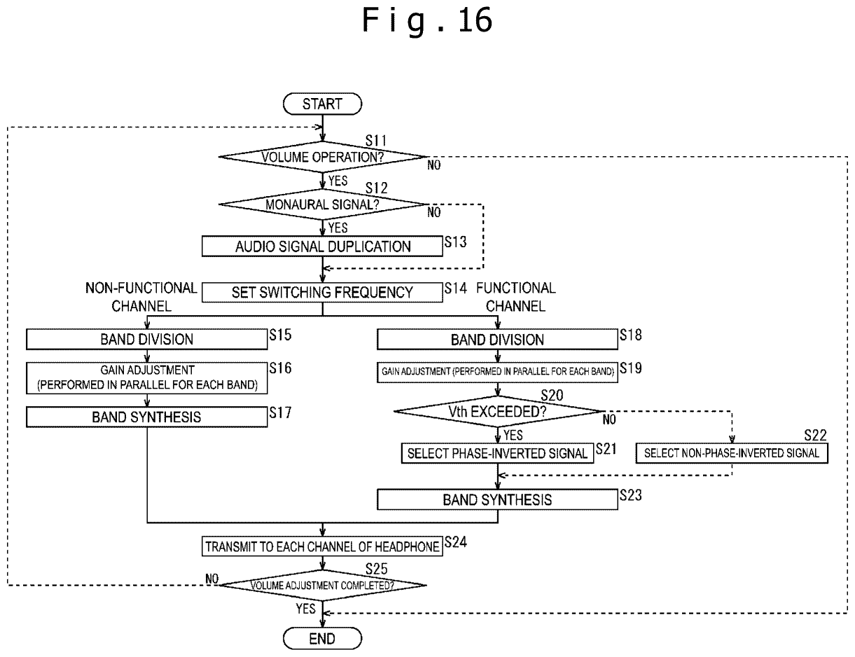

Volume processing executed by the playback device 100 illustrated in FIG. 15 is described below with reference to the flowchart of FIG. 16.

At step S11, whether a volume operation has been performed is determined. When the user wants to change the volume, he or she operates the volume adjustment operation section 121. The volume adjustment operation section 121 is a slide bar displayed on the display unit 101 of the playback device 100, and by operating the knob of the slide bar, the user sets the desired volume as described above with reference to FIG. 5, for example.

At step S11, when it is determined that the volume adjustment operation section 121 has been operated, the processing proceeds to step S12. At step S12, whether the target sound to be processed is a monaural signal is determined. At step S12, when it is determined that the target sound is a monaural signal, the processing proceeds to step S13. At step S13, the signal duplication unit 133 prepares audio signals for two channels by duplicating the audio signal of the target sound read from the content storage unit 131 and selected by the input selection unit 132. The signal duplication unit 133 supplies one audio signal M1 to the band division unit 134-1 and supplies the other audio signal M2 to the band division unit 134-2.

On the other hand, at step S12, when it is determined that the target sound to be processed is not a monaural signal, that is, a stereo signal, the process of step S13 is skipped, and the processing proceeds to step S14. At step S12, when it is determined that the signal is a stereo signal, an audio signal S1 of one channel read from the content storage unit 131 and selected by the input selection unit 132 is supplied to the band division unit 134-1, and an audio signal S2 of the other channel is supplied to the band division unit 134-2.

Processing on the supplied audio signals in the functional channel and the non-functional channel is started. The processing for the functional channel is performed by the band division unit 134-1, the gain control units 135-1, 135-2, and 135-3, the phase inversion unit 136, the signal selection unit 137, the signal addition unit 138-1, and the setting unit 139 of the playback device 100. The processing for the non-functional channel is performed by the band division unit 134-2, the gain control units 135-4 and 135-5, the signal addition unit 138-2, and the setting unit 139 of the playback device 100.

At step S14, a switching frequency is set. The switching frequency refers to the switching frequency Fcut1, the switching frequency Fcut2, and the switching frequency Fmax described above with reference to FIG. 6, for example. The switching frequency refers to a frequency for setting the frequency band (inversion frequency band) for performing the psychological sound pressure adjustment when the specified volume is set to a value exceeding the switching value Vth (threshold Vth) where the psychological sound pressure adjustment is started, and a boundary frequency between the inversion frequency band and the non-inversion frequency band.

The switching frequency is a frequency for setting the inversion frequency band when the specified volume is set to a value exceeding the switching value Vth for starting the psychological sound pressure adjustment, and therefore, if the specified volume does not exceed the switching value Vth, it is not necessary to set the inversion frequency band in terms of processing.

It is possible to adopt a configuration and processing for the playback device 100 in which the inversion frequency band is not specified when it is unnecessary, and the physical sound pressure adjustment is performed on the audio signal across the entire frequency band without distinguishing between the inversion frequency band and the non-inversion frequency band. In a case where such a configuration and processing are adopted, different processing is performed depending on whether the specified volume exceeds the switching value Vth.

In a case where processing is performed on the basis of the configuration of the playback device 100 illustrated in FIG. 15 and the processing of the flowchart illustrated in FIG. 16, even when the specified volume does not exceed the switching value Vth, the switching frequency is set, and the audio signal is separated into the signal for the inversion frequency band and the signal for the non-inversion frequency band, thereby performing the processing for each audio signal.

The playback device 100 illustrated in FIG. 15 is configured to perform the same processing regardless of whether the specified volume exceeds the switching value Vth. For example, the band division unit 134 is configured to be provided in the same number as the number of channels, and to perform band division regardless of whether the specified volume exceeds the switching value Vth, for example. With this configuration, there is no need for a configuration for switching the processing depending on whether the specified volume exceeds the switching value Vth, such as a plurality of processing units for different processes or a plurality of switches for selecting which processing unit to use among the plurality of processing units, and thus the configuration of the playback device 100 can be simplified.

At step S14, a switching frequency is set to each of the band division units 134-1 and 134-2 from the table setting unit 171 of the setting unit 139. The following describes the case described with reference to FIG. 6 as an example.

When the specified volume has a value from volume V0 to V8, the frequency Fcut1 is set to each of the band division units 134-1 and 134-2. When the specified volume is the volume V9, the frequency Fcut2 is set to each of the band division units 134-1 and 134-2. When the specified volume is the volume V10, the frequency Fmax is set to each of the band division units 134-1 and 134-2.

Note that the table setting unit 171 stores the table described with reference to FIGS. 9 to 14, and the switching frequency based on the table is set to the band division units 134-1 and 134-2.

When the switching frequency is set to each of the band division units 134-1 and 134-2, processing in each of the functional channel and the non-functional channel is started. First, processing performed on the non-functional channel side is described.

At step S15, the band division unit 134-2 performs band division of the audio signal M2 or the audio signal S2 at the set switching frequency. For example, when the switching frequency is the switching frequency Fcut1, the signal is divided into an audio signal L2 on the lower-frequency side of the switching frequency Fcut1 and an audio signal H2 on the higher-frequency side of the switching frequency Fcut1. The audio signal L2 divided by the band division unit 134-2 is supplied to the gain control unit 135-4, and the audio signal H2 is supplied to the gain control unit 135-5.

At step S16, the gain control unit 135-4 adjusts the gain such that the supplied audio signal L2 has a sound pressure corresponding to the specified volume, thereby generating an audio signal Gn*L2. A gain value is supplied to the gain control unit 135 from the setting unit 139, and the gain control unit 135 adjusts the gain to a sound pressure corresponding to the specified volume on the basis of the gain value.

In the case of the example described with reference to FIG. 6, when the specified volume is equal to or less than the volume V7, the gain is adjusted to a sound pressure corresponding to the specified volume by the physical sound pressure adjustment, thereby generating the audio signal Gn*L2. When the specified volume is equal to or greater than the volume V7, the psychological sound pressure adjustment and the physical sound pressure adjustment are performed, and therefore, the gain is adjusted such that a sound pressure corresponds to the specified volume when the sound pressure corresponding to the volume increased by the psychological enhancement is added thereto, thereby generating the audio signal Gn*L2.

The gain control unit 135-5 adjusts the gain of the supplied audio signal H2 to the sound pressure corresponding to the specified volume, thereby generating an audio signal Gm*H2. In the case of the example described with reference to FIG. 6, the gain of the audio signal H2 on the high-frequency side is adjusted to the sound pressure corresponding to the specified volume by the physical sound pressure adjustment, thereby generating the audio signal Gm*H2.

At step S17, band synthesis is performed by the signal addition unit 138-2. The signal addition unit 138-2 is supplied with the audio signal Gn*L2 from the gain control unit 135-4 and the audio signal Gm*H2 from the gain control unit 135-5. The signal addition unit 138-2 generates an audio signal C2, which is an audio signal before being divided by the band division unit 134-2 and has been subjected to gain adjustment, by adding the supplied audio signal Gn*L2 and audio signal Gm*H2, and supplies the audio signal C2 to the signal transmission unit 140.

While the above-described gain adjustment is performed in the non-functional channel, gain adjustment is also performed on the audio signal on the functional channel side.

At step S18, the band division unit 134-1 performs band division of the audio signal M1 or the audio signal S1 at the set switching frequency. For example, when the switching frequency is the switching frequency Fcut1, the signal is divided into an audio signal L1 on the lower-frequency side of the switching frequency Fcut1 and an audio signal H1 on the higher-frequency side of the switching frequency Fcut1. The audio signal L1 divided by the band division unit 134-1 is supplied to the gain control unit 135-1 and the gain control unit 135-2, and the audio signal H1 is supplied to the gain control unit 135-3.

At step S19, the gain control unit 135-1 and the gain control unit 135-2 adjust the gain of the supplied audio signal L1 to the sound pressure corresponding to the specified volume, thereby generating an audio signal Gn*L1.

In the case of the example described with reference to FIG. 6, when the specified volume is equal to or less than the volume V7, the gain control unit 135-1 adjusts the gain to a sound pressure corresponding to the specified volume by the physical sound pressure adjustment, thereby generating the audio signal Gn*L1. When the specified volume is equal to or greater than the volume V7, the psychological sound pressure adjustment and the physical sound pressure adjustment are performed, and the gain control unit 135-1 adjusts the gain such that a sound pressure corresponds to the specified volume when the sound pressure corresponding to the volume increased by the psychological enhancement is added thereto, thereby generating the audio signal Gn*L1.

The audio signal Gn*L1 generated by the gain control unit 135-1 is supplied to the phase inversion unit 136, and the supplied audio signal Gn*L1 is phase-inverted and then supplied to the signal selection unit 137 as the phase-inverted audio signal Gn*L1′. In this manner, regardless of the specified volume, the phase-inverted signal is generated for the audio signal set to the inversion frequency band.

The gain control unit 135-2 adjusts the gain to a sound pressure corresponding to the specified volume by the physical sound pressure adjustment regardless of the specified volume, thereby generating an audio signal Gm*L1. The audio signal Gm*L1 generated by the gain control unit 135-2 is supplied to the signal selection unit 137.

In the functional channel, an audio signal in which the audio signal in the inversion frequency band is phase-inverted, and an audio signal in which the audio signal in the inversion frequency band is not phase-inverted are generated.

As described above, with the configuration in which the processing of generating an inverted audio signal and a non-inverted audio signal is performed regardless of the specified volume, the configuration of the playback device 100 can be simplified. In addition, since synchronized processing can be performed by preventing one of the non-functional channel and the functional channel from being delayed relative to the other, the need for processing or a configuration for inserting a buffer, which is necessary when considering delays, can be eliminated.

At step S19, gain adjustment by the gain control unit 135-3 is also performed. The gain control unit 135-3 generates an audio signal Gm*H1 by adjusting the gain of the audio signal H1 supplied from the band division unit 134-1 to the sound pressure corresponding to the specified volume, and supplies the audio signal Gm*H1 to the signal selection unit 137.

At step S20, the signal selection unit 137 determines whether the specified volume exceeds the threshold Vth. When the signal selection unit 137 determines that the specified volume exceeds the threshold Vth, the processing proceeds to step S21. Proceeding the process to step S21 means that the psychological sound pressure adjustment is determined to be performed, and therefore, the signal selection unit 137 selects the phase-inverted audio signal Gn*L1′ supplied from the phase inversion unit 136 and supplies it to the signal addition unit 138-1.

On the other hand, at step S20, when the signal selection unit 137 determines that the specified volume does not exceed the threshold Vth, the processing proceeds to process step S22. Proceeding the process to step S22 means that the psychological sound pressure adjustment is determined to be not performed, and therefore, the signal selection unit 137 selects the non-phase-inverted audio signal Gm*L1 supplied from the gain control unit 135-2 and supplies it to the signal addition unit 138-1.

At step S23, the signal addition unit 138-1 performs band synthesis. The signal addition unit 138-1 is supplied with the audio signal Gn*L1′ or the audio signal Gm*L1 selected by the signal selection unit 137 and the audio signal Gm*H1 from the gain control unit 135-3. The signal addition unit 138-1 generates an audio signal C1 that has been subjected to gain adjustment by adding the supplied audio signal Gn*L1′ or the audio signal Gm*L1 and the audio signal Gm*H1, and supplies it to the signal transmission unit 140.

Each of the non-functional channel and the functional channel performs basically the same processing, namely the band division, gain control, and signal addition. Processing can be performed without causing a delay of one of the audio signal processed on the non-functional channel side and the audio signal processed on the functional channel side relative to the other.

For example, it is not necessary to provide a buffer to perform processing of preventing a delay of one of the audio signal processed on the non-functional channel side and the audio signal processed on the functional channel side, and thus the configuration and processing of the playback device 100 can be simplified.

By performing processing in each of the non-functional channel and the functional channel, the signal transmission unit 140 is supplied with audio signals for two channels to be supplied to the external apparatus 50. At step S24, the audio signal is transmitted to each channel of the external apparatus 50 such as a headphone. When acquiring audio signals supplied from the signal addition unit 138-1 and the signal addition unit 138-2, the signal transmission unit 140 transmits the audio signal to the instructed channel of the external apparatus 50 on the basis of information for identifying channels supplied from the channel setting unit 172.

At step S25, whether the volume adjustment has been completed is determined, and when it is determined that the volume adjustment has not been completed, the processing is returned to step S11 to repeat the subsequent processing, whereas when it is determined that the volume adjustment has been completed, the processing related to the volume processing illustrated in FIG. 16 is completed. For example, when the user has finished the operation of the volume adjustment operation section 121, in other words, when the specified volume is no longer supplied, the processing related to the volume processing illustrated in FIG. 16 is completed.

### Another Configuration of Playback Device

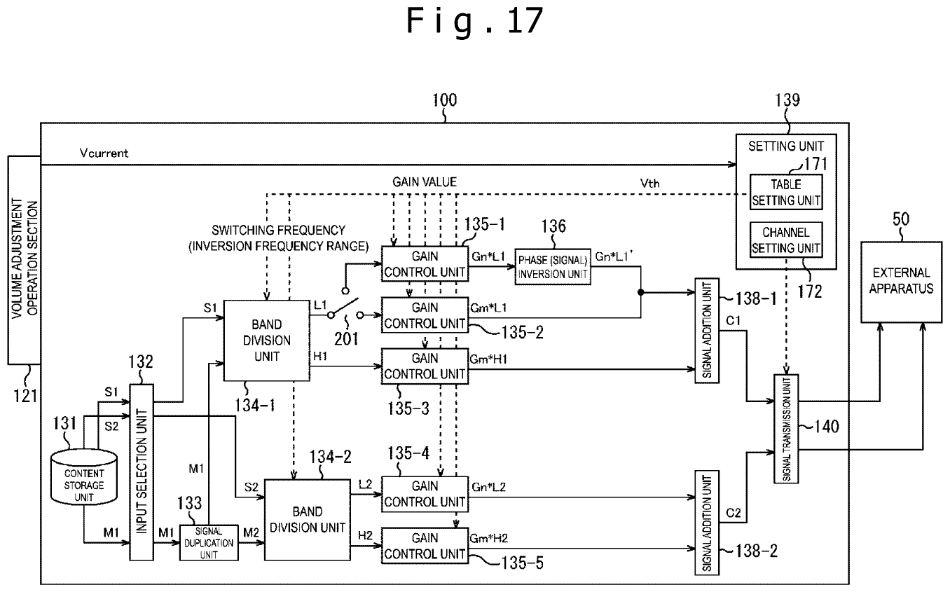

FIG. 17 is a diagram illustrating another configuration of the playback device 100. The playback device 100 illustrated in FIG. 17 is different from the playback device 100 illustrated in FIG. 15 in that it includes switch 201, and other points are basically the same.

The switch 201 is provided between the band division unit 134-1 and the gain control unit 135-1 and between the band division unit 134-1 and the gain control unit 135-2, and is configured such that when the switch 201 is switched, the audio signal L1 from the band division unit 134-1 is supplied to either the gain control unit 135-1 or the gain control unit 135-2.

When the specified volume specified by the user is equal to or greater than the switching value Vth at which the psychological sound pressure adjustment is started, the switch 201 is connected to the gain control unit 135-1, whereas when the specified volume is less than the switching value Vth, the switch 201 is connected to the gain control unit 135-2. When the switch 201 is connected to the gain control unit 135-1, the audio signal L1 from the band division unit 134-1 is supplied to the gain control unit 135-1, where the audio signal L1 is subjected to gain adjustment, and then the signal is supplied to the phase inversion unit 136, phase-inverted by the phase inversion unit 136, and supplied to the signal addition unit 138-1.

When the switch 201 is connected to the gain control unit 135-2, the audio signal L1 from the band division unit 134-1 is supplied to the gain control unit 135-2, where the audio signal L1 is subjected to gain adjustment, and then the signal is supplied to the signal addition unit 138-1.

In the playback device 100 illustrated in FIG. 17 as well, processing is basically performed on the basis of the flowchart illustrated in FIG. 16, and therefore, the description thereof is omitted here.

Note that if there is a possibility that providing the switch 201 may cause a processing load or time delay such as from instructions to the switch 201 or the time consumed for switching, a configuration may be adopted in which a buffer is provided in the portion that performs processing on the functional channel side or the portion that performs processing on the non-functional channel side.

### Another Psychological Sound Pressure Adjustment

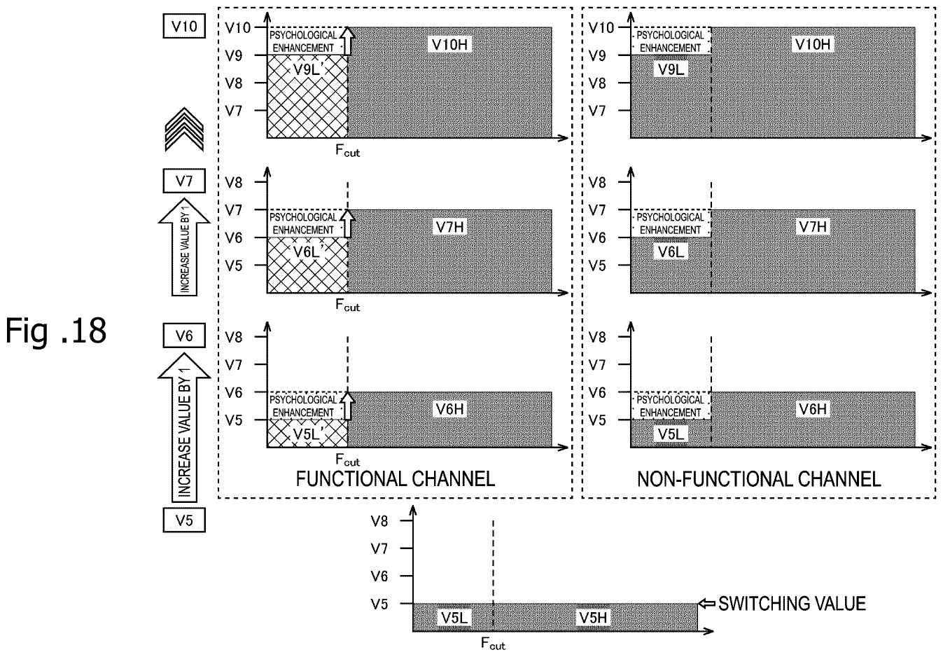

With reference to FIG. 18, another adjustment method for the psychological sound pressure adjustment is described.

The psychological sound pressure adjustment described above with reference to FIG. 6 uses the three switching frequency bands, namely, the switching frequencies Fcut1, Fcut2, and Fmax to perform processing, but the psychological sound pressure adjustment described below with reference to FIG. 18 uses one switching frequency Fcut to perform processing. Descriptions of parts similar to those described with reference to FIG. 6 are omitted as appropriate.

When the specified volume is volume V0 to V5, the control is performed such that the specified volume is set by the physical sound pressure adjustment. In the example illustrated in FIG. 6, a case is described, as an example, in which the switching value Vth at which the psychological sound pressure adjustment is started is the volume V7, but in the example illustrated in FIG. 18, a case is described, as an example, in which the switching value Vth at which the psychological sound pressure adjustment is started is the volume V5. The switching value Vth can be set to an appropriate value by a method of the psychological sound pressure adjustment.

When the volume V6 is specified as the specified volume, not only the physical sound pressure adjustment, but also the psychological sound pressure adjustment is started.

In the functional channel, to set the volume to the volume V6, the psychological sound pressure adjustment is performed in the inversion frequency band, whereas the physical sound pressure adjustment is performed in the non-inversion frequency band. The inversion frequency band is set to, for example, the range from 0 to Fcut, and for the audio signal in that inversion frequency band, the physical sound pressure adjustment (gain adjustment) is performed up to the volume V5, and the audio signal corresponding to the volume V5 is inverted, thereby performing psychological volume enhancement and generating an audio signal corresponding to the volume V6.

In the functional channel, for the audio signal in the inversion frequency band, an audio signal V5L′ obtained by inverting the audio signal V5L set to the volume V5 level by the physical sound pressure adjustment is generated. Since inverting the audio signal in the frequency band up to the frequency Fcut results in the volume enhancement equivalent to one level, the audio signal V5L′ becomes an audio signal equivalent to the volume V6.

For the audio signal in the frequency band equal to or greater than the frequency Fcut, an audio signal V6H at the volume V6 level is generated by the physical sound pressure adjustment.

Also in the non-functional channel, to set the volume to the volume V6, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V5, thereby generating the audio signal V5L corresponding to the volume V5. The inversion of the audio signal on the functional channel side results in psychological enhancement equivalent to one level, and as a result, an audio signal V6L corresponding to the volume V6 is obtained.

Also on the non-functional channel side, for the audio signal in the frequency band equal to or greater than the frequency Fcut, an audio signal V6H at the volume V6 level is generated by the physical sound pressure adjustment.

When the volume V7 is specified as the specified volume, in the functional channel, to set the volume to the volume V7, the psychological sound pressure adjustment is performed in the inversion frequency band, whereas the physical sound pressure adjustment is performed in the non-inversion frequency band. The inversion frequency band is set to the range from 0 to Fcut. In the functional channel, for the audio signal in the inversion frequency band, an audio signal V6L′ obtained by inverting the audio signal V6L set to the volume V6 level by the physical sound pressure adjustment is generated. Since inverting the audio signal in the frequency band up to the frequency Fcut results in the volume enhancement equivalent to one level, the audio signal V6L′ becomes an audio signal equivalent to the volume V7.

For the audio signal in the frequency band equal to or greater than the frequency Fcut, an audio signal V7H at the volume V7 level is generated by the physical sound pressure adjustment.

Also in the non-functional channel, to set the volume to the volume V7, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V6, thereby generating the audio signal V6L corresponding to the volume V6. The inversion of the audio signal on the functional channel side results in psychological enhancement equivalent to one level, and as a result, an audio signal V7L corresponding to the volume V7 is obtained.

Also on the non-functional channel side, for the audio signal in the frequency band equal to or greater than the frequency Fcut, an audio signal V7H at the volume V7 level is generated by the physical sound pressure adjustment.

In the case where the volume V8, the volume V9, and the volume V10 are specified as the specified volume as well, processing is performed in the same manner as for the above-described volume V6 and volume V7.

Here, a case is described, as an example, in which one switching frequency Fcut is set, and the switching frequency is set to a frequency at which psychological enhancement of one level is obtained in the inversion frequency band, but the switching frequency Fcut to be set is not limited to the frequency at which the psychological enhancement of one level is obtained in the inversion frequency band, and may be set to frequencies at which psychological enhancement of a plurality of levels such as two levels or three levels, for example, is obtained in the inversion frequency band.

In a case where processing is performed with one switching frequency Fcut, only one switching frequency is supplied from the table setting unit 171 to the band division units 134-1 and 134-2, and therefore, the switching frequency Fcut may be directly set in the band division units 134-1 and 134-2, without providing instructions from the table setting unit 171. In addition, in the case where processing is performed with one switching frequency Fcut, the configurations of the band division units 134-1 and 134-2 can be simplified more than the case where processing is performed with a plurality of switching frequencies Fcut.

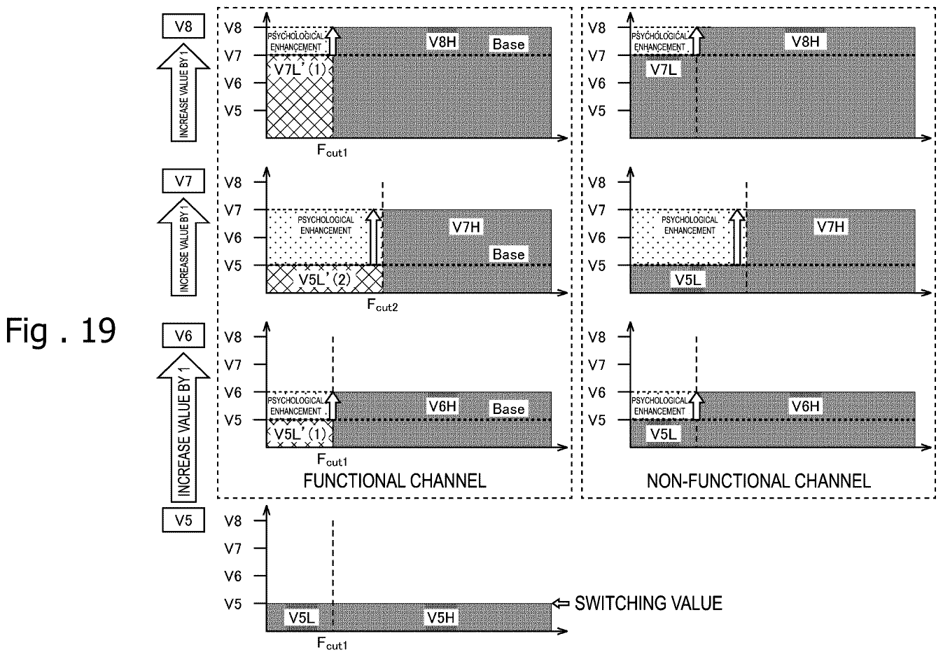

With reference to FIG. 19, still another adjustment method for the psychological sound pressure adjustment is described.

In the psychological sound pressure adjustment described below with reference to FIG. 19, two switching frequencies, namely, the switching frequency Fcut1 and the switching frequency Fcut2, are set and used in such a manner that the two switching frequencies are alternately switched. The following describes, as an example, a case in which the switching frequency Fcut1 and the switching frequency Fcut2 are similar to the switching frequency Fcut1 and the switching frequency Fcut2 described with reference to FIG. 6, and the switching frequency Fcut1 represents a frequency band in which psychological enhancement equivalent to one level is obtained, whereas the switching frequency Fcut2 represents a frequency band in which psychological enhancement equivalent to two levels is obtained. Descriptions of parts similar to those described with reference to FIG. 6 are omitted as appropriate.

When the specified volume is volume V0 to V5, the control is performed such that the specified volume is set by the physical sound pressure adjustment. When the volume V6 is specified as the specified volume, not only the physical sound pressure adjustment, but also the psychological sound pressure adjustment is started.

In the functional channel, to set the volume to the volume V6, the psychological sound pressure adjustment is performed in the inversion frequency band, whereas the physical sound pressure adjustment is performed in the non-inversion frequency band. The inversion frequency band is set to, for example, the range from 0 to Fcut1, and for the audio signal in the inversion frequency band, the physical sound pressure adjustment (gain adjustment) is performed up to the volume V5, and the audio signal corresponding to the volume V5 is inverted, thereby performing psychological enhancement equivalent to one level, and generating an audio signal corresponding to the volume V6.

In the functional channel, for the audio signal in the inversion frequency band, an audio signal V5L′(1) obtained by inverting the audio signal V5L set to the volume V5 level by the physical sound pressure adjustment is generated. Since inverting the audio signal in the frequency band up to the frequency Fcut1 results in the volume enhancement equivalent to one level, the audio signal V5L′ becomes an audio signal equivalent to the volume V6.

For the audio signal in the frequency band equal to or greater than the frequency Fcut1, an audio signal V6H at the volume V6 level is generated by the physical sound pressure adjustment.

Also in the non-functional channel, to set the volume to the volume V6, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V5, thereby generating the audio signal V5L corresponding to the volume V5. The inversion of the audio signal on the functional channel side results in psychological enhancement equivalent to one level, and as a result, the audio signal V5L corresponding to the volume V6 is obtained.

Also on the non-functional channel side, for the audio signal in the frequency band equal to or greater than the frequency Fcut1, an audio signal V6H at the volume V6 level is generated by the physical sound pressure adjustment.

When the volume V7 is specified as the specified volume, in the functional channel, to set the volume to the volume V7, the psychological sound pressure adjustment is performed in the inversion frequency band, whereas the physical sound pressure adjustment is performed in the non-inversion frequency band. The inversion frequency band is switched to the range from 0 to Fcut2, for example. In the functional channel, for the audio signal in the inversion frequency band, an audio signal V5L′(2) obtained by inverting the audio signal V5L set to the volume V5 level by the physical sound pressure adjustment is generated. Since inverting the audio signal in the frequency band up to the frequency Fcut2 results in the volume enhancement equivalent to two levels, the audio signal V5L′(2) becomes an audio signal equivalent to the volume V7.

For the audio signal in the frequency band equal to or greater than the frequency Fcut2, an audio signal V7H at the volume V7 level is generated by the physical sound pressure adjustment.

Also in the non-functional channel, to increase the volume by one level from the volume V6 to the volume V7, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V5, thereby generating the audio signal V5L corresponding to the volume V5. The inversion of the audio signal on the functional channel side results in psychological enhancement equivalent to two levels, and as a result, the audio signal V5L corresponding to the volume V7 is obtained.

Also on the non-functional channel side, for the audio signal in the frequency band equal to or greater than the frequency Fcut2, an audio signal V7H at the volume V7 level is generated by the physical sound pressure adjustment.

When the volume V8 is specified as the specified volume, in the functional channel, to set the volume to the volume V8, the psychological sound pressure adjustment is performed in the inversion frequency band, whereas the physical sound pressure adjustment is performed in the non-inversion frequency band. The inversion frequency band is reset again to the range from 0 to Fcut1, and for the audio signal in the inversion frequency band, the physical sound pressure adjustment (gain adjustment) is performed up to the volume V7, and the audio signal corresponding to the volume V7 is inverted, thereby performing psychological enhancement equivalent to one level, and generating the audio signal V7L′(1) corresponding to the volume V8.

In the functional channel, for the audio signal in the inversion frequency band, the audio signal V7L′(1) obtained by inverting the audio signal V7L set to the volume V7 level by the physical sound pressure adjustment is generated. Since inverting the audio signal in the frequency band up to the frequency Fcut1 results in the volume enhancement equivalent to one level, the audio signal V7L′(1) becomes an audio signal equivalent to the volume V8.

For the audio signal in the frequency band equal to or greater than the frequency Fcut1, an audio signal V8H at the volume V8 level is generated by the physical sound pressure adjustment.

Also in the non-functional channel, to set the volume to the volume V8, the psychological sound pressure adjustment is performed in the inversion frequency band, whereas the physical sound pressure adjustment is performed in the non-inversion frequency band. For the audio signal in the inversion frequency band, the physical sound pressure adjustment (gain adjustment) is performed up to the volume V7, thereby generating the audio signal V7L corresponding to the volume V7. The inversion of the audio signal on the functional channel side results in psychological enhancement equivalent to one level, and as a result, the audio signal V7L corresponding to the volume V8 is obtained.

Also on the non-functional channel side, for the audio signal in the frequency band which is equal to or greater than the frequency Fcut1, an audio signal V8H at the volume V8 level is generated by the physical sound pressure adjustment.

In this manner, the psychological sound pressure adjustment may be performed by alternately using two switching frequencies (two inversion frequency bands). Note that while an example in which two switching frequencies are used has been described above, it is also applicable to a case where two or more switching frequencies are set and sequentially switched, and the same switching frequencies are repeatedly set.

In the psychological sound pressure adjustment described with reference to FIGS. 18 and 19, when the specified volume is equal to or greater than the volume V5, the sound pressure adjustment by the physical sound pressure adjustment is performed only up to the sound pressure corresponding to the volume V less than the specified volume. For example, while continuously listening at a relatively high volume may lead to the deterioration of auditory function, it is possible to prevent the deterioration of auditory function even when the user listens to sound at a relatively high volume for an extended period, vary the effect of BMLD while providing the listener with a natural auditory sensation, and allow the listener to listen at a desired volume without causing frequency imbalance between the sound in the inversion frequency band and the sound in the non-inversion frequency band.

Note that while an example is described in the above-described embodiment assuming that the external apparatus 50 is a two-channel headphone or earphone, sound conduction methods may also include bone conduction, and the present technology may also be applied to a playback device that supplies audio signals to headphones or earphones using bone conduction.

Note that while an example is described in the above-described embodiment assuming that the external apparatus 50 is a two-channel device such as headphones or earphones, the present technology may also be applied to a configuration in which two or more speakers such as multichannel speakers are installed. In the case where the present technology is applied to a configuration in which a plurality of speakers are installed, at least one of the plurality of speakers is set as a functional channel, and the psychological sound pressure adjustment is performed.

### Recording Medium

The series of processes described above may be executed by hardware or may be executed by software. When the series of processes is executed by software, a program constituting the software is installed in a computer. Here, the computer includes a computer embedded in dedicated hardware or, for example, a general-purpose personal computer that can execute various functions by installing various programs.

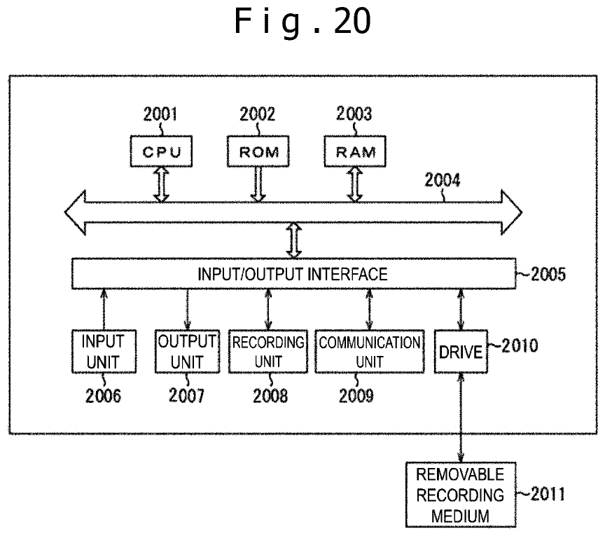

FIG. 20 is a block diagram illustrating a configuration example of the hardware of a computer that executes the above-described series of processes using a program. In the computer, a central processing unit (CPU) 2001, a read only memory (ROM) 2002, and a random access memory (RAM) 2003 are mutually connected via a bus 2004. Further, an input/output interface 2005 is connected to the bus 2004. An input unit 2006, an output unit 2007, a storage unit 2008, a communication unit 2009, and a drive 2010 are connected to the input/output interface 2005.

The input unit 2006 is composed of a keyboard, a mouse, a microphone, and the like. The output unit 2007 is composed of a display, a speaker, and the like. The storage unit 2008 is composed of a hard disk, a nonvolatile memory, and the like. The communication unit 2009 is composed of a network interface and the like. The drive 2010 drives a removable medium 2011 such as a magnetic disc, an optical disk, a magneto-optical disc, or a semiconductor memory.

In the computer configured as described above, the series of processes described above is executed by the CPU 2001 loading a program stored in the storage unit 2008 into the RAM 2003 via the input/output interface 2005 and the bus 2004, and executing the program.

The program executed by the computer (CPU 2001) may be provided by being recorded on the removable medium 2011 such as a package medium. The program may also be provided via a wired or wireless transmission medium such as a local area network, the Internet, or digital satellite broadcasting.

In the computer, the program may be installed in the storage unit 2008 via the input/output interface 2005 by mounting the removable medium 2011 in the drive 2010. The program may also be received via a wired or wireless transmission medium by the communication unit 2009 and installed in the storage unit 2008. Alternatively, the program may be preinstalled in the ROM 2002 or the storage unit 2008.

Note that the program executed by the computer may be a program for executing processing in time series in the order described in the present specification, or may be a program for executing processing in parallel or at necessary timings such as when called.

In the present specification, the system refers to the entirety of a device composed of a plurality of devices.

Note that the effects described in the present specification are merely illustrative and not limiting, and other effects may also be included.

Note that the embodiment of the present technology is not limited to the embodiment described above, and various modifications may be made without departing from the gist of the present technology.

Note that the present technology may be configured as follows.
(1)

An information processing device including a processing unit configured to process an audio signal of at least two channels, in which the processing unit sets a part of a band of the audio signal as an inversion frequency band, and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.
(2)

The information processing device according to (1), in which the part of the band is changed in accordance with a set volume adjustment value.
(3)

The information processing device according to (1) or (2), further including a band division unit configured to divide the band of the audio signal into the inversion frequency band and the non-inversion frequency band, the number of band division units being the same as the number of channels.
(4)

The information processing device according to any one of (1) to (3), in which, as the audio signal to be supplied to the second channel, a second added signal obtained by adding a third audio signal corresponding to the inversion frequency band and a fourth audio signal corresponding to the non-inversion frequency band is generated.
(5)

The information processing device according to (4), in which the first audio signal and the third audio signal are audio signals subjected to gain adjustment so as to be audio signals corresponding to a volume less than a set volume adjustment value.
(6)

The information processing device according to (4), in which the second audio signal and the fourth audio signal are audio signals subjected to gain adjustment so as to be audio signals corresponding to a set volume adjustment value.
(7)

The information processing device according to (4), in which the inverted signal obtained by phase-inverting the first audio signal subjected to gain adjustment so as to be an audio signal corresponding to a volume less than a set volume adjustment value and a fifth audio signal subjected to gain adjustment so as to be an audio signal corresponding to the volume adjustment value are generated, and the first added signal is generated by adding one of the inverted signal or the fifth audio signal with the second audio signal in accordance with the volume adjustment value.
(8)

The information processing device according to (4), in which the third audio signal and the fourth audio signal are generated from an audio signal obtained by duplicating an audio signal before being divided into the first audio signal and the second audio signal.
(9)

The information processing device according to any one of (1) to (8), in which one frequency is set as a boundary frequency between the inversion frequency band and the non-inversion frequency band.
(10)

The information processing device according to any one of (1) to (9), in which a plurality of frequencies are set as a boundary frequency between the inversion frequency band and the non-inversion frequency band, and the plurality of frequencies are sequentially repeatedly used.
(11)

An information processing method by an information processing device configured to process a sound and including a processing unit configured to process an audio signal of at least two channels, the method including, by the processing unit,
setting a part of a band of the audio signal as an inversion frequency band and another part of the band of the audio signal as a non-inversion frequency band,
generating, as the audio signal to be supplied to a first channel, a first added signal by adding an inverted signal obtained by phase-inverting a first audio signal corresponding to the inversion frequency band and a second audio signal corresponding to the non-inversion frequency band, and
performing gain adjustment on an audio signal to be supplied to at least one of the first channel or the second channel.
(12)

A program causing a computer to function as a processing unit configured to process an audio signal of at least two channels, in which the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

50 External apparatus, 100 Playback device, 101 Display unit, 121 Volume adjustment operation section, 131 Content storage unit, 132 Input selection unit, 133 Signal duplication unit, 134 Band division unit, 135 Gain control unit, 136 Phase inversion unit, 137 Signal selection unit, 138 Signal addition unit, 139 Setting unit, 140 Signal transmission unit, 171 Table setting unit, 172 Channel setting unit, 201 Switch

1. An information processing device comprising
a processing unit configured to process an audio signal of at least two channels, wherein
the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.

2. The information processing device according to claim 1,
wherein the part of the band is changed in accordance with a set volume adjustment value.

3. The information processing device according to claim 1, further comprising
a band division unit configured to divide the band of the audio signal into the inversion frequency band and the non-inversion frequency band, the number of band division units being the same as the number of channels.

4. The information processing device according to claim 1,
wherein as the audio signal to be supplied to the second channel, a second added signal obtained by adding a third audio signal corresponding to the inversion frequency band and a fourth audio signal corresponding to the non-inversion frequency band is generated.

5. The information processing device according to claim 4,
wherein the first audio signal and the third audio signal are audio signals subjected to gain adjustment so as to be audio signals corresponding to a volume less than a set volume adjustment value.

6. The information processing device according to claim 4,
wherein the second audio signal and the fourth audio signal are audio signals subjected to gain adjustment so as to be audio signals corresponding to a set volume adjustment value.

7. The information processing device according to claim 4,
wherein the inverted signal obtained by phase-inverting the first audio signal subjected to gain adjustment so as to be an audio signal corresponding to a volume less than a set volume adjustment value and a fifth audio signal subjected to gain adjustment so as to be an audio signal corresponding to the volume adjustment value are generated, and
the first added signal is generated by adding one of the inverted signal or the fifth audio signal with the second audio signal in accordance with the volume adjustment value.

8. The information processing device according to claim 4,
wherein the third audio signal and the fourth audio signal are generated from an audio signal obtained by duplicating an audio signal before being divided into the first audio signal and the second audio signal.

9. The information processing device according to claim 1,
wherein one frequency is set as a boundary frequency between the inversion frequency band and the non-inversion frequency band.

10. The information processing device according to claim 1,
wherein a plurality of frequencies are set as a boundary frequency between the inversion frequency band and the non-inversion frequency band, and
the plurality of frequencies are sequentially repeatedly used.

11. An information processing method by an information processing device configured to process a sound and including a processing unit configured to process an audio signal of at least two channels, the method comprising: by the processing unit,
setting a part of a band of the audio signal as an inversion frequency band and another part of the band of the audio signal as a non-inversion frequency band;
generating, as the audio signal to be supplied to a first channel, a first added signal by adding an inverted signal obtained by phase-inverting a first audio signal corresponding to the inversion frequency band and a second audio signal corresponding to the non-inversion frequency band; and
performing gain adjustment on an audio signal to be supplied to at least one of the first channel or the second channel.

12. A program causing a computer to function as a processing unit configured to process an audio signal of at least two channels,
wherein the processing unit sets a part of a band of the audio signal as an inversion frequency band and another part of the band of the audio signal as a non-inversion frequency band, generates, as the audio signal to be supplied to a first channel, a first added signal by adding an inverted signal obtained by phase-inverting a first audio signal corresponding to the inversion frequency band and a second audio signal corresponding to the non-inversion frequency band, and performs gain adjustment on an audio signal to be supplied to at least one of the first channel or the second channel.
